(19) United States
(12) Patent Application Publication
(10) Pub. No.: US 2009/0080081 A1
(43) Pub. Date: Mar. 26, 2009

(54) OPTICAL FILM, POLARIZING PLATE AND IMAGE DISPLAY DEVICE

(76) Inventors: Katsumi Inoeu, Kanagawa (JP); Tetsuya Asakura, Kanagawa (JP); Naohiro Matsunaga, Shizuoka (JP); Jun Watanabe, Kanagawa (JP); Hiroyuki Yoneyama, Kanagawa (JP)

Correspondence Address: BIRCH STEWART KOLASCH & BIRCH, PO BOX 747, FALLS CHURCH, VA, 22040-0747, US

(21) Appl. No.: 12/234,169

(22) Filed: Sep. 19, 2008

(30) Foreign Application Priority Data
Sep. 20, 2007 (JP) 2007-243512
Mar. 28, 2008 (JP) 2008-088533

(51) Int. Cl. G02B 5/00

(52) U.S. Cl. 359/601

(57) ABSTRACT

An optical film includes: a transparent substrate; and an antiglare layer containing a light transmissive resin and a first light transmissive particle, and having a thickness of from 8 to 15 μm, wherein the first light transmissive particle has a particle size of from 5.5 to 10 μm and a refractive index of from 1.55 to 1.58, and a ratio of the particle size of the first light transmissive particle to the thickness of the antiglare layer is from 0.30 to 0.75.

### CROSS-REFERENCE TO RELATED APPLICATIONS

This application claims the benefit of Japanese Patent Application JP 2007-243512, filed Sep. 20, 2007, and JP 2008-088533, filed Mar. 28, 2008, the entire contents of which are hereby incorporated by reference, the same as if set forth at length.

### FIELD OF THE INVENTION

This invention relates to an optical film, a polarizing plate having the optical film, and an image display device having the optical film or the polarizing plate.

### BACKGROUND OF THE INVENTION

Various image display devices such as liquid crystal displays (LCDs), plasma display panels (PDPs), electroluminescence displays (ELDs), and cathode ray tubes (CRTs) have an antiglare film or an antiglare antireflection film on their outermost surface to prevent the reduction of contrast due to reflection of ambient and image light. To cope with the widespread use of display devices in offices and homes, it has been demanded to improve antiglare properties to prevent the reflection of ambient fluorescent lamps or a viewer on the screen and to further improve display contrast in bright lighting.

An antiglare film having a surface roughness to scatter external light has the image quality problem that the surface light diffusion decreases the depth of blacks. That is, to achieve a balance between antiglare performance and depth of blacks has been a problem to be solved.

To address the problem, an antiglare film containing fine particles with an average particle size of 6 to 15 μm has been proposed, e.g., in JP-A-2007-41533. The antiglare hard coat film of JP-A-2007-41533 preferably has a thickness of 15 to 35 μm, which invites disadvantages, such as reduced productivity (because of an increased amount of a coating), increased curling, increased brittleness, and increased thickness which is against the demand for reduced thickness of display devices.

In seeking for an antiglare film having antiglare performance and depth of blacks in good balance, it is necessary for the film to perform the antiglare function against light incident at various angles from various light sources and also to improve the depth of blacks when viewed in a bright environment from both the vertical and off-vertical directions to the display. There is no technique to date that can achieve high levels of both antiglare properties and depth of blacks as evaluated in terms of the above mentioned criteria within a film thickness range up to 15 μm that favors productivity, anti-curling, and toughness (non-brittleness) and contributes to display thickness reduction.

### SUMMARY OF THE INVENTION

An aspect of the present invention is to provide an optical film for use on a display surface that is excellent in antiglare performance and depth of blacks as well as in terms of productivity, anti-curling, toughness, and contribution to display thickness reduction.

Another aspect of the invention is to provide an optical film that provides a display device with a good display contrast and produces excellent effects in improving viewing angle characteristics and antiglare properties.

Still another aspect of the invention is to provide a polarizing plate having the optical film, and an image display device having the optical film or the polarizing plate.

As a result of extensive researches, the present inventors have found that an antiglare film having a thickness of 8 to 15 μm and yet exhibiting excellent antiglare properties and providing improved depth of blacks can be obtained by using particles having a specific particle size and a specific refractive index. The present invention has been completed based on this finding.

The invention provides in its first aspect an optical film having a transparent substrate and an antiglare layer on the substrate. The antiglare layer contains a light transmissive resin and light transmissive particles (hereinafter “particles A”). The antiglare layer has a thickness (t) of 8 to 15 μm. The particle A has a particle size (dA) of 5.5 to 10 μm and a refractive index (npA) of 1.55 to 1.58. The ratio of the particle size of the light transmissive particles (dA) to the antiglare layer thickness (t) (dA/t) is 0.30 to 0.75.

The invention provides preferred embodiments of the optical film, in which:
(1) the antiglare layer further contains second light transmissive particles (hereinafter “particles B”), the particle size of which is substantially the same as that of the particles A;
(2) the particles B have a refractive index of 1.49 to 1.54;
(3) the optical film further comprises a low refractive index layer having a lower refractive index than the antiglare layer;
(4) the optical film has an integrated reflectance of 3.5% or less;
(5) the optical film has a surface profile having a centerline average roughness (centerline roughness average) Ra of 0.05 to 0.25 μm and a mean spacing between profile peaks Sm of 60 to 150 μm;
(6) the optical film has a surface profile having a slope distribution with an average slope θa of 0.5° to 3.0° and a peak slope θp of 0.3° or less;
(7) the optical film has a surface haze (a haze due to surface light scattering) of 0.2% to 10%; or
(8) the optical film has an internal haze (a haze due to internal light scattering) of 1% to 40%.

The invention also provides in its second aspect a polarizing plate comprising a polarizer and two protective films each of which protects either sides of the polarizer. At least one of the protective films is the optical film of the invention.

The invention also provides in its third aspect an image display device having the optical film of the invention or the polarizing plate of the invention.

The invention also provides in its fourth aspect an LCD having the optical film of the invention or the polarizing plate of the invention.

The present invention provides an optical film (antiglare film) for use on a display surface that is excellent in antiglare performance and depth of blacks as well as in terms of productivity, anti-curling, toughness, and contribution to display thickness reduction. The invention also provides a polarizing plate and an image display device excellent in antiglare properties and depth of blacks.

### BRIEF DESCRIPTION OF THE DRAWINGS

FIGS. 1A, 1B and 1C show-diagrams explaining the method of measuring an average slope of the surface profile of the optical film according to the present invention.

### DETAILED DESCRIPTION OF THE INVENTION

The optical film of the invention includes a transparent substrate and an antiglare layer provided on the substrate. The antiglare layer contains a light transmissive resin and light transmissive particles (particles A). The antiglare layer has a thickness (t) of 8 to 15 μm. The particles A have a particle size (dA) of 5.5 to 10 μm and a refractive index (npA) of 1.55 to 1.58. The ratio of the particle size of the light transmissive particles (dA) to the thickness (t) (dA/t) is 0.30 to 0.75.

The optical film of the invention has at least one antiglare layer on the transparent substrate. The antiglare layer has light transmissive particles dispersed in a light transmissive resin matrix. The number of the antiglare layer in the optical film may be one or more, for example, 2 to 4.

Examples of preferred layer structures of the optical film according to the invention are shown below, in which the base film is a substrate of film form.
(1) Base film/antiglare layer
(2) Base film/antistatic layer/antiglare layer
(3) Base film/antiglare layer/low refractive index layer
(4) Base film/antiglare layer/antistatic layer/low refractive index layer
(5) Base film/hard coat layer/antiglare layer/low refractive index layer
(6) Base film/hard coat layer/antiglare layer/antistatic layer/low refractive index layer
(7) Base film/hard coat layer/antistatic layer/antiglare layer/low refractive index layer
(8) Base film/antiglare layer/high refractive index layer/low refractive index layer
(9) Base film/antiglare layer/medium refractive index layer/high refractive index layer/low refractive index layer
(10) Antistatic layer/base film/antiglare layer/medium refractive index layer/high refractive index layer/low refractive index layer
(11) Base film/antistatic layer/antiglare layer/medium refractive index layer/high refractive index layer/low refractive index layer
(12) Antistatic layer/base film/antiglare layer/high refractive index layer/low refractive index layer/high refractive index layer low refractive index layer

As alluded to above, the optical film of the invention may have optional layers other than the antiglare layer, such as a hard coat layer, an antistatic layer, a low refractive index layer, and a stainproof layer. It is preferred that the antiglare layer combine the function as a hard coat layer, an antistatic layer, a stainproof layer, and the like. It is preferred that at least one of the medium refractive index layer and the high refractive index layer function as an antistatic layer. In the case where the optical film contains the three-layer structure of medium refractive index layer/high refractive index layer/low refractive index layer, it is preferred that the medium refractive index layer serve the function as the antistatic layer in view of obtaining desired antistatic properties while providing a refractive index as designed.

In terms of achieving reduction of reflection, the optical film of the invention is preferably an antireflective antiglare film containing a layer structure of medium refractive index layer/high refractive index layer/low refractive index layer. Examples of such an antireflection, antiglare layer are described, e.g., in JP-A-8-122504, JP-A-8-110401, JP-A-10-300902, JP-A-2002-243906, JP-A-2000-111706. From the viewpoint of simplicity and productivity of the manufacture, the most preferred embodiments of the invention are an optical film having one antiglare layer on the substrate and an antireflective antiglare film having one antiglare layer and one low refractive index layer on the substrate in the order described.

The antiglare layer used in the invention is formed by applying a coating composition containing light transmissive particles having an average particle size of 5.5 to 10 μm (particles A), a matrix forming component (e.g., a monomer providing a binder), and an organic solvent and drying and curing the coating layer. As used herein, the term “particle size” means a primary particle size.

The coating composition forming the antiglare layer contains a monomer that polymerizes (cures) by, e.g., an ionizing radiation to form a light transmissive polymer serving as a main matrix-forming binder, light transmissive particles having the recited particle size, a polymerization initiator, and optionally preferably a polymer for adjusting the viscosity of the coating composition, an inorganic particulate filler for curling reduction and refractive index control, a coating aid, and so forth.

The optical film of the invention, polarizing plate, and image display device of the present invention are required to perform a satisfactory antiglare function in a broad range of conditions of use involving various light incident angles from various light sources. Among the methods of evaluating antiglare performance under such a variety of use environments is a method of evaluating antiglare performance using a light source with a varied width and at a varying light incident angle. With respect to depth of blacks, it is desirable to achieve good depth of blacks when a display is viewed in a bright environment from both the vertical and off-vertical directions to the display.

The thickness of the antiglare layer is 8 to 15 μm, preferably 10 to 15 μm, more preferably 11 to 15 μm. If it is less than 8 μm, the resulting film has too large surface roughness because of the presence of the particles with the specific particle size, which deteriorates the depth of blacks in a lighted room. A thickness exceeding 15 μm is unfavorable from the standpoint of productivity, anti-curling, toughness, and display thickness reduction.

The antiglare layer contains first light transmissive particles (particles A) having an average particle size (dA) of 5.5 to 10 μm and a refractive index (npA) of 1.55 to 1.58.

The refractive index (npA) of the particles A is 1.55 to 1.58, preferably 1.56 to 1.57. If the refractive index (npA) is smaller than 1.55, in the case when a general-purpose, polyfunctional acrylate compound (described infra) is used as a main monomer providing a matrix forming binder, the particles A will have high affinity to the binder so that the particles are better dispersible in the monomer and are less agglomerated in the film. This results in a failure to achieve both excellent antiglare performance and sufficient depth of blacks as long as the antiglare layer thickness is in the recited range. If, on the other hand, the refractive index is greater than 1.58, in the case when a general purpose, polyfunctional acrylate compound (described infra) is used as a main monomer providing a matrix forming binder, agglomeration of the particles in the film is too much, resulting in large surface roughness as long as the antiglare layer thickness is in the recited range. As a result, the display provides whitish blacks and low contrast in a bright environment.

The refractive indices as referred to in the invention are values obtained when the refractive index of crosslinked polymethyl methacrylate particles and that of crosslinked polystyrene particles are 1.49 and 1.59, respectively.

The refractive index of particles may be measured as follows. Mixed solvents having any two solvents having different refractive indices chosen from methylene iodide, 1,2-dibromopropane, and n-hexane at varied mixing ratios to have varied refractive indices are prepared. In each of the mixed solvents are dispersed an equivalent amount of light transmissive particles, and the turbidity of the dispersion is measured. The refractive index of the mixed solvent in which the particles are dispersed with the least turbidity is measured with an Abbe refractometer. The thus measured refractive index is higher than the refractive index of the mixed solvent by 0.01. For instance, the refractive index of crosslinked polymethyl methacrylate particles is 1.50 as measured by this method. Accordingly, when the refractive index of particles is measured by this method, the measured value minus 0.01 can be used for comparison with the data recited in the description of the present invention.

In order to achieve both excellent antiglare performance and depth of blacks with the recited antiglare layer thickness, it is necessary to control not only the refractive index but particle size of the particles.

The particles A have an average particle size (dA) of 5.5 to 10 μm, preferably 5.5 to 9.0 μm, more preferably 5.5 to 8.5 μm. If the particle size is smaller than 5.5 μm, the optical film with the recited thickness provides poor depth of blacks, failing to achieve both excellent antiglare performance and depth of blacks at the same time. Furthermore, wide-angle scattering increases to causes low display contrast. If the particle size is larger than 10 μm, the optical film with the recited thickness exhibits poor antiglare performance, failing to achieve both excellent antiglare properties and depth of blacks at the same time. Moreover, the optical film will have a very rough surface texture and a poor appearance. Furthermore, the optical film produces only a small amount of light scatter, resulting in insufficient prevention of glare. In addition to the refractive index and particle size, the ratio of the particle size of the light transmissive particles (dA) to the thickness (t) (dA/t) is of importance. The ratio (dA/t) is 0.30 to 0.75, preferably 0.35 to 0.65, more preferably 0.40 to 0.65. A ratio (dA/t) larger than 0.75 means excessive surface roughness only to provide a poor appearance. A ratio (dA/t) smaller than 0.30 results in poor depth of blacks. The object of the present invention cannot be accomplished until all the above described conditions of refractive index (npA), particle size (dA), and particle size/thickness ratio (dA/t) are fulfilled.

In order to obtain desirable internal scattering properties, it is preferred to use particles the refractive index of which is different from that of the matrix by a specific amount. In order to obtain preferred internal scatter, the difference in refractive index between the particles A and the matrix is preferably 0.02 to 0.20, more preferably 0.02 to 0.10, and even more preferably 0.02 to 0.07. It is preferred that the refractive index of the particles A fulfill the above specified refractive index difference from the matrix and be higher than that of the matrix.

In cases where internal scatter by the particles A is insufficient, it is preferred to use second light transmissive particles (hereinafter “particles B”). The second particles preferably have a refractive index falling in the above recited range. Particles with a high refractive index tend to agglomerate too much and can rather deteriorate the excellent antiglare performance and depth of blacks obtained by the particles A. Accordingly, in the case of using a general-purpose, polyfunctional acrylate compound (described infra) as a main monomer providing a matrix forming binder, the second light transmissive particles preferably have a refractive index of 1.49 to 1.54, more preferably 1.49 to 1.52, even more preferably 1.49 to 1.51, to reduce agglomeration of the particles. Because the refractive index of light transmissive particles affects both the agglomeration of the particles and internal scatter in the binder, it is particularly preferred to use the particles A in combination with the particles B so as to control the agglomeration of the particles and internal scatter in the optimum ranges.

In order to avoid the particles B adversely affecting the good antiglare performance and depth of blacks as obtained by the particles A, it is preferred that the particle size (dB) of the particles B is substantially the same as that of the particles A. The term “substantially the same particle size” as used herein is intended to mean that the B to A particle size ratio (dB/dA) is in the range of 0.90 to 1.10, preferably 0.95 to 1.05, more preferably 0.97 to 1.03. When the B to A particle size ratio is out of the range, use of the particles B is liable to cause a change in surface profile, which is unfavorable to antiglare performance and depth of blacks.

The amount of the particles A to be used is preferably 3% to 20% by mass, more preferably 4% to 15% by mass, based on the total solids content of the antiglare layer. When the particles A and B are used in combination, they are used in a total amount preferably of 4% to 30% by mass, more preferably 6% to 25% by mass, even more preferably 8% to 20% by mass, based on the total solids content of the antiglare layer. The proportion of the particles A in the total particles is preferably at least 50% by mass, more preferably 60% by mass or more, even more preferably 70% by mass or more. The upper limit of the proportion of the particles A in the total particles is 100% by mass, preferably 90% by mass. The antiglare layer may contain one or more kinds of particles different from the particles A and/or B satisfying their respective preferred ranges. When in using particles that do not satisfy the preferred ranges of the particles A or B, the proportion of such particles in the total particles (A+B) is preferably 30% by mass or less, more preferably 20% by mass or less, even more preferably 10% by mass or less, most preferably 0%.

The particles A and particles B are chosen from the particles described below in accordance with the above recited ranges of refractive index and average particle size.

The light transmissive particles that can be used in the present invention can be resin particles and/or inorganic particles.

Preferred examples of the resin of the resin particles include crosslinked polymethyl methacrylate, crosslinked methyl methacrylate-styrene copolymers, crosslinked polystyrene, crosslinked methyl methacrylate-methyl acrylate copolymers, crosslinked acrylate-styrene copolymers, melamine-formaldehyde resins, and benzoguanamine-formaldehyde resins. Preferred of them are crosslinked polystyrene, crosslinked polymethyl methacrylate, and crosslinked methyl methacrylate-styrene copolymers. Surface modified resin particles having the above described material as a core particle and a compound containing a fluorine atom, a silicon atom, a carboxyl group, a hydroxyl group, an amino group, a sulfonic acid group, a phosphoric acid group, or the like chemically bonded to the surface of the core particle and resin particles of the above described material having inorganic nanoparticles of silica, zirconia, etc. bonded to the surface thereof are also used preferably.

Fine inorganic particles are also useful as light transmissive particles. Preferred examples of the inorganic particles are silica particles and alumina particles, with silica particles being more preferred. Resin particles are preferred to the inorganic particles as the particles A.

Where it is desired to set the refractive index of the matrix at 1.54 or smaller, preferably 1.53 or smaller, for the purpose of making coating unevenness or interference unevenness less noticeable or from the viewpoint of cost, it is particularly preferred to use, as particles A, crosslinked polymethyl methacrylate particles or crosslinked methyl methacrylate-styrene copolymer particles. Crosslinked methyl methacrylate-styrene copolymer particles are especially preferred. In using crosslinked methyl methacrylate-styrene copolymer particles, the copolymerization ratio of styrene is preferably 55% to 95%, more preferably 60% to 90%, even more preferably 65% to 85%. It is particularly preferred to use as the particles B crosslinked polymethyl methacrylate particles or crosslinked methyl methacrylate-styrene particles. In using crosslinked methyl methacrylate-styrene copolymer particles as particles B, the copolymerization ratio of styrene is preferably 50% or less, more preferably 30% or less, even more preferably 20% or less. By so adjusting the copolymerization ratio of styrene in the particles A and B, the above specified preferred ranges of refractive index can be satisfied.

While the particles may be either spherical or amorphous, spherical particles are preferred. It is desirable that the particles have a mono-dispersed particle size distribution in view of haze/diffusion controllability and coating surface uniformity. Particles with a size 20% or more greater than the average particle size being defined as coarse particles, the proportion of the coarse particles in all the particles is preferably 1% or less, more preferably 0.1% or less, even more preferably 0.01% or less. Existence of too much coarse particles results in an unfavorable lumpy texture.

Particles with a size 16% or more smaller than the average particle size being defined as fine particles, the proportion of such fine particles in all the particles is preferably 10% or less, more preferably 6% or less, even more preferably 4% or less.

Mono-dispersed partieles with such a narrow size distribution are prepared by classification of particles as synthesized in a usual manner. An increased number of times of classification and/or an increased degree of classification result in a narrower and thus more desirable size distribution. Classification is preferably carried out by air classification, centrifugation, sedimentation, filtration, electrostatic classification or a like method.

The particle size distribution of the particles is measured with a Coulter counter. The measured distribution is converted to a number distribution. An average particle size is calculated from the resulting particle distribution.

The binder that forms the matrix of the antiglare layer is preferably a light transmissive polymer having a saturated hydrocarbon main chain or a polyether main chain as a result of curing with, e.g., an ionizing radiation. The cured main binder polymer preferably has a crosslinked structure.

The binder polymer having a saturated hydrocarbon main chain as a result of curing is preferably exemplified by those obtained by polymerization of at least one ethylenically unsaturated monomer selected from a first group of compounds listed below.

The binder polymer having a polyether main chain as a result of curing is preferably exemplified by those obtained by ring-opening polymerization of at least one epoxy monomer selected from a second group of compounds listed below.

### First Group of Compounds:

The binder polymer having a saturated hydrocarbon main chain and a crosslinked structure is preferably a (co)polymer of a monomer having at least two ethylenically unsaturated groups per molecule. To achieve a high refractive index, the monomer preferably contains an aromatic ring or at least one atom selected from halogen except fluorine, sulfur, phosphorus, and nitrogen.

Examples of the monomer having at least two ethylenically unsaturated groups that can be used to provide a binder polymer as a matrix of the antiglare layer include (meth)acrylic acid esters with polyhydric alcohols, such as ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, and polyester polyacrylate; vinylbenzene and its derivatives, such as 1,4-divinylbenzene, 2-acryloylethyl 4-vinylbenzoate and 1,4-divinylcyclohexanone; vinylsulfones, such as divinylsulfone; and (meth)acrylamides, such as methylenebisacrylamide. As used herein, the term “(meth)acrylic” includes acrylic and/or methacrylic. The same applies to the terms “(meth)acrylate”, “(meth)acryloyl”, and “(meth)acrylamide”. To minimize shrinkage on curing thereby to prevent curling, addition of ethylene oxide, propylene oxide or caprolactone to these monomers is preferred to widen the distance between crosslinking points. Examples of such adduct monomers include ethylene oxide-added trimethylolpropane triacrylate (e.g., V#360 from Osaka Organic Chemical Industry, Ltd.), propylene oxide-added glycerol triacrylate (e.g., V#GPT from Osaka Organic Chemical Industry, Ltd.), and caprolactone-added dipentaerythritol hexaacrylate (e.g., DPCA-20 or -120, from Nippon Kayaku Co., Ltd.). It is also preferred to use two or more monomers having at least two ethylenically unsaturated groups.

Resins having at least two ethylenically unsaturated groups and relatively low molecular weights are also preferred monomers. Such resins include polyester resins, polyether resins, acrylic resins, epoxy resins, urethane resins, alkyd resins, spiroacetal resins, polybutadiene resins, polythiol polyene resins, and oligomers or prepolymers of polyfunctional compounds such as polyhydric alcohols. These monomers can be used either individually or as a combination thereof. The resin having at least two ethylenically unsaturated groups is preferably used in a proportion of 10% to 100% based on the total binder.

Polymerization of the monomer having ethylenically unsaturated groups is performed by applying an ionizing radiation or heat in the presence of a photo radical polymerization initiator or thermal radical polymerization initiator. Therefore, the antiglare layer of the invention can be formed by the steps of preparing a coating composition containing the ethylenically unsaturated monomer, a photo or thermal radical polymerization initiator, the particles, and necessary additives such as an inorganic filler and a coating aid, an organic solvent, and so forth; applying the coating composition to a transparent substrate, and applying an ionizing radiation or heat to the coating film to induce polymerization curing. A combination of ionizing radiation curing and thermal curing is effective as well. The photo and thermal polymerization initiators to be used may be selected from commercially available compounds, examples of which are described, e.g., in Saishin UV Koka Gijyutu, Technical Information Institute Co., Ltd., p. 159, 1991 and the catalogue of Ciba Specialty Chemicals.

### Second Group of Compounds:

The following epoxy compounds (or epoxy monomers) are preferably used to reduce shrinkage on curding. These epoxy monomers preferably contain at least two epoxy groups per molecule, examples of which are described, e.g. in JP-A-2004-264563, JP-A-2004-264564, JP-A-2005-37737, JP-A-2005-37738, JP-A-2005-140862, JP-A-2005-140862, JP-A-2005-140863, and JP-A-2002-322430.

The amount of the epoxy monomer to be used is preferably 20% to 100% based on the total binder by mass in terms of curing shrinkage reduction. The amount of epoxy monomer is more preferably 35% to 100% by mass, even more preferably 50% to 100% by mass.

Examples of a photoacid generator that produces a cation by the action of light and is used to induce polymerization of the epoxy monomer include ionic compounds such as triarylsulfonium salts and diaryliodonium salts and nonionic compounds such as nitrobenzyl sulfonate. Various known photoacid generators described, e.g., in JEOM (ed.), Imaging-yo Yuki Zairyo, Bunshin Shuppan (1977) can be made use of. Preferred of them are sulfonium salts and iodonium salts having, as a counter ion, PF₆⁻, SbF₆⁻, AsF₆⁻, and B (C₆F₅)₄⁻, etc.

The polymerization initiator is preferably used in an amount of 0.1 to 15 parts by mass, more preferably 1 to 10 parts by mass, per 100 parts by mass of the compound selected from the first or the second groups.

The coating composition for antiglare layer may contain a high molecular compound (polymer). Addition of a high molecular compound to the coating composition is effective in reducing curing shrinkage or adjusting the viscosity of the coating composition.

The high molecular compound is a component having the form of a polymer at the time of addition to the coating composition. Examples of useful high molecular compound include cellulose esters (e.g., cellulose triacetate, cellulose diacetate, cellulose propionate, cellulose acetate propionate, cellulose acetate butyrate, and cellulose nitrate), polyurethane acrylates, polyester acrylates, poly(meth)acrylates (e.g., a methyl methacrylate/methyl acrylate copolymer, methyl methacrylate/ethyl(meth)acrylate copolymer, a methyl methacrylate/butyl(meth)acrylate copolymer, a methyl methacrylate/styrene copolymer, a methyl methacrylate/(meth)acrylic acid copolymer, and methyl polymethacrylate), and polystyrene.

The high molecular compound is preferably used in an amount of 1% to 50% by mass, more preferably 5% to 40% by mass, based on the total binder present in the layer containing the high molecular compound in view of the inhibitory effects on curing shrinkage and the viscosity increasing effect. The weight average molecular weight of the high molecular compound is preferably 3000 to 400,000, more preferably 5000 to 300,000, even more preferably 5000 to 200,000.

The antiglare layer may further contain an inorganic filler in addition to the particles A and B for the purpose of refractive index adjustment, film strength enhancement, reduction of curing shrinkage, and, in the case of providing a low refractive index layer, for the purpose of reflectance reduction. For example, it is preferred to add fine, high-refractive-index inorganic filler particles of a metal oxide containing at least one of titanium, zirconium, aluminum, indium, zinc, tin, and antimony and having an average primary particle size usually of 0.2 μm or smaller, preferably 0.1 μm or smaller, more preferably 1 nm to 0.06 μm.

In the case when the refractive index of the matrix needs to be lowered to adjust the refractive index difference between the particles A and B, a fine, low-refractive-index inorganic filler such as silica particles or hollow silica particles may be added. A preferred particle size of the low refractive index inorganic filler is the same as that of the high refractive index inorganic filler.

The inorganic filler may be surface treated with a silane coupling agent or titanium coupling agent. A surface treating agent introducing a functional group reactive with the binder species to the filler surface is preferably used.

The amount of the fine inorganic filler to be added is preferably 10% to 90% by mass, more preferably 20% to 80% by mass, even more preferably 30% to 75% by mass, based on the total mass of the antiglare layer.

The fine inorganic filler does not cause light scattering because of their sufficiently smaller particle size than the wavelengths of light. Therefore, a dispersion of the filler in the binder polymer has properties of an optically uniform substance.

The coating composition providing the antiglare layer preferably contains a fluorine surface active agent and/or a silicone surface active agent to avoid coating problems such as application unevenness, drying unevenness, and coating surface defects such as spots. A fluorine surface active agent is particularly preferred; for it produces at a smaller amount of addition substantial improving effects on application unevenness, drying unevenness, and coating surface defects such as spots. The surface active agent is added for the purpose of imparting suitability to high speed application to the coating composition as well as improving surface uniformity, thereby to increase productivity.

Preferred examples of the fluorine surface active agent are described, e.g., in JP-A-2007-188070, paras. 0049-0074.

The amount of the surface active agent (e.g., fluoropolymer) to be added is preferably 0.001% to 5% by mass, more preferably 0.005% to 3% by mass, even more preferably 0.01% to 1% by mass, based on the coating composition. Addition of 0.001% by mass or more of a fluoropolymer produces sufficient effects. Addition of 5% by mass or less of a fluoropolyner secures sufficient drying of the coating film to provide a layer with good performance properties such as reflectance and scratch resistance.

The coating composition providing the antiglare layer can contain an organic solvent.

Examples of suitable organic solvents include alcohols such as methanol, ethanol, n-propanol, isopropyl alcohol, n-butanol, isobutanol, sec-butanol, tert-butanol, isoamyl alcohol, 1-pentanol, n-hexanol, and methylamyl alcohol; ketones such as methyl isobutyl ketone (MIBK), methyl ethyl ketone (MEK), diethyl ketone, acetone, cyclohexanone, and diacetone alcohol; esters such as methyl acetate, ethyl acetate, n-propyl acetate, isopropyl acetate, isobutyl acetate, n-butyl acetate, isoamyl acetate, n-amyl acetate, methyl propionate, ethyl propionate, methyl butyrate, ethyl butyrate, methyl acetate, methyl lactate, and ethyl lactate; ethers and acetals such as 1,4-dioxane, tetrahydrofuran, 2-methylfuran, tetrahydropyran, and diethyl acetate; hydrocarbons such as hexane, heptane, octane, isooctane, ligroin, cyclohexane, methylcyclohexane, toluene, xylene, ethylbenzene, styrene, and divinylbenzene; halogenated hydrocarbons such as carbon tetrachloride, chloroform, methylene chloride, ethylene chloride, 1,1,1-trichloroethane, 1,1,2-trichloroethane, trichloroethylene, tetrachloroethylene, and 1,1,1,2-tetrachloroethane; polyhydric alcohols and derivatives thereof such as ethylene glycol, ethylene glycol monomethyl ether, ethylene glycol monoethyl ether, ethylene glycol monoacetate, diethylene glycol, propylene glycol, dipropylene glycol, butanediol, hexylene glycol, 1,5-pentanediol, glycerol monoacetate, glycerol ethers, and 1,2,6-hexanetriol; fatty acids such as formic acid, acetic acid, propionic acid, butyric acid, isobutyric acid, isovaleric acid, and lactic acid; nitrogen-containing compounds such as formamide, N,N-dimethylformamide, acetamide, and acetonitrile; and sulfur-containing compounds such as dimethyl sulfoxide.

Preferred of the organic solvents are methyl isobutyl ketone, methyl ethyl ketone, cyclohexanone, acetone, toluene, xylene, ethyl acetate, and 1-pentanol. For the purpose of agglomeration control, an alcohol or polyhydric alcohol solvent may be appropriately mixed therewith. These organic solvents can be used either individually or as a mixture thereof. The total amount of the organic solvents in the coating composition is preferably 20% to 90% by weight, more preferably 30% to 80% by weight, even more preferably 40% to 70% by weight. In order to stabilize the surface shape of the antiglare layer, it is preferred to use a solvent having a boiling point lower than 100° C. and a solvent having a boiling point of 100° C. or higher in combination.

The antiglare layer is preferably formed by applying the coating composition to a substrate and inducing crosslinking or polymerization by light irradiation, electron beam irradiation, heating, and the like. In the case of UV irradiation, useful UV light sources include an ultrahigh pressure mercury lamp, a high pressure mercury lamp, a low pressure mercury lamp, a carbon arc lamp, a xenon arc lamp, and a metal halide lamp. UV-curing is preferably carried out in an atmosphere having an oxygen concentration reduced by, for example, purging with nitrogen to 4% by volume or less, more preferably 2% by volume or less, even more preferably 0.5% by volume or less.

Layers other than the antiglare layer will then be described.

To reduce the reflectance of the optical film of the invention, a low refractive index layer is preferably provided. The refractive index of the low refractive index layer is preferably 1.20 to 1.46, more preferably 1.25 to 1.46, even more preferably 1.30 to 1.40.

The low refractive index layer preferably has a thickness of 50 to 200 nm, more preferably 70 to 100 nm, and a haze of 3% or less, more preferably 2% or less, even more preferably 1% or less.

Examples of preferred embodiments of the cured product compositions as a low refractive index layer include (1) a composition containing a fluorine-containing compound having a crosslinking or polymerizable functional group, (2) a composition composed mainly of a hydrolysis and condensation product of a fluorine-containing organosilane material, and (3) a composition containing a monomer having at least two ethylenically unsaturated groups and inorganic fine particles, particularly preferably hollow inorganic fine particles. It is preferred for the compositions (1) and (2) to contain inorganic fine particles. Hollow inorganic fine particles are preferred in terms of refractive index reduction.

### (1) Composition Containing Fluorine-Containing Compound Having a Crosslinking or Polymerizable Functional Group

The fluorine-containing compound having a crosslinking or polymerizable functional group is exemplified by a copolymer of a fluorine-containing monomer and a monomer having a crosslinking or polymerizable functional group. Examples of such a fluoropolymer are given in JP-A-2003-222702 and JP-A-2003-183322.

The above described fluoropolymer may be used in combination with an appropriate curing agent having a polymerizable unsaturated group as taught in JP-A-2000-17028. A combined use with a compound having a fluorine-containing, polyfunctional, polymerizable, unsaturated group is also preferred. Examples of the compound having a polyfunctional polymerizable unsaturated group include the above recited monomers having at least two ethylenically unsaturated groups. The hydrolysis and condensation product of an organosilane described in JP-A-2004-170901 is also preferred. A hydrolysis and condensation product of an organosilane containing a (meth)acryloyl group is particularly preferred.

These compounds greatly contribute to the improvement of scratch resistance particularly when combined with a compound having a polymerizable unsaturated group as a main polymer.

Where the polymer alone has insufficient curability, sufficient curability can be imparted by compounding with a crosslinking compound. For example, in using a polymer having a hydroxyl group, various amino compounds are suitably used as a curing agent. Examples of the amino compounds serving as a crosslinking curing agent include those containing two or more functional groups selected from a hydroxylalkylamino group and an alkoxyalkylamino group, such as melamine compounds, urea compounds, benzoguanamine compounds, and glycoluril compounds. An organic acid or a salt thereof is preferably used to cure these compounds.

### (2) Composition Mainly Containing Hydrolysis and Condensation Product of Fluorine-Containing Organosilane Material

The composition mainly containing hydrolysis and condensation product of fluorine-containing organosilane material is also preferred for its low refractive index and high hardness of the coating film surface. A condensation product between a compound having a hydrolysable silanol group at one or both terminals with respect to a fluoroalkyl group and a tetraalkoxysilane is preferred. Specific compositions are described in JP-A-2002-265866 and Japanese Patent 317152.

### (3) Composition Containing a Monomer Having at Least Two Ethylenically Unsaturated Groups and Hollow Inorganic Fine Particles

A low refractive index layer composed of low refractive index particles and a binder is another preferred embodiment. The low refractive index particles, which may be either organic or inorganic, are preferably hollow particles, the examples of which include the silica particles described in JP-A-2002-79616. The refractive index of the particles is preferably 1.15 to 1.40, more preferably 1.20 to 1.30. Examples of the binder include the monomers having at least two ethylenically unsaturated groups recited with reference to the antiglare layer.

It is preferred to add to the low refractive index layer a polymerization initiator such as those described with reference to the antiglare layer. In using a radical polymerizable compound to form the low refractive index layer, the amount of the polymerization initiator to be added is 1 to 10 parts by mass, preferably 1 to 5 parts by mass, per 100 parts by mass of the compound.

The low refractive index layer may contain inorganic particles. To provide the low refractive index layer with scratch resistance, fine inorganic particles having a particle size ranging 15% to 150%, preferably 30% to 100%, even more preferably 45% to 60%, the thickness of the layer are used.

To provide the low refractive index layer with stain-proof properties, water resistance, chemical resistance, and slip properties, the layer may contain as appropriate known polysiloxane or fluorine type additives as a stain-proof agent or a slip agent.

The polysiloxane type additive nay be a reactive group-containing polysiloxane. Examples thereof include KF-100T, X-22-169AS, KF-102, X-22-3701IE, X-22-164B, X-22-5002, X-22-173B, X-22-174D, X-22-167B, and X-22-161AS (all available from Shin-Etsu Chemical Co., Ltd.); AK-5, AK-30, and AK-32 (all available from Toa Gosei Co., Ltd.); and SILAPLANE FM0725 and FM0721 (available from Chisso Corp.). The silicone compounds listed in Tables 2 and 3 of JP-A-2003-112383A are also preferably used.

The fluorine compound as an additive is preferably those having a fluoroalkyl group. The fluoroalkyl group preferably has 1 to 20 carbon atoms, more preferably 1 to 10 carbon atoms, and may be straight-chain (e.g., —CF₂CF₃, —CH₂ (CF₂)₄H, —CH₂ (CF₂)₈CF₃, or —CH₂CH₂(CF₂)₄), branched (e.g., CH(CF₃)₂, CH₂CF(CF₃)₂, CH(CH₃)CF₂CF₃, or CH(CH₃) (CF₂)₅CF₂H), or alicyclic (preferably 5- or 6-membered, e.g., perfluorocyclohexyl, perfluorocyclopentyl or an alkyl group substituted with perfluorocyclohexyl or perfluorocyclopentyl). The fluoroalkyl group may contain an ether bond (e.g., CH₂OCH₂CF₂CF₃, CH₂CH₂OCH₂C₄F₈H, CH₂CH₂OCH₂CH₂C₈F₁₇, or CH₂CH₂OCF₂CF₂OCF₂CF₂H). The fluorine compound may have two or more fluoroalkyl groups per molecule.

The fluorine compounds preferably further contains at least one, preferably two or more substituents contributory to bond formation or compatibility to the low refractive index layer, which may be the same or different. Exemplary and preferred such substituents are acryloyl, methacryloyl, vinyl, aryl, cinnamoyl, epoxy, oxetanyl, hydroxyl, polyoxyalkylene, carboxyl, and amino. The fluorine compound is not limited in molecular weight; it may be a copolymer with a fluorine-free compound or an oligomer. The fluorine content of the fluorine compound is preferably, but not limited to, 20% by mass or more, more preferably 30% to 70% by mass, even more preferably 40% to 70% by mass. Exemplary and preferred fluorine compounds include, but are not limited to, R-2020, M-2020, R-3833, M-3833, and Optool DAC (all trade names, available from Daikin Industries, Ltd.); and Megafac F-171, F-172, and F-179A and Defensa MCF-300 and MCF-323 (all trade names, available from Dainippon Ink & Chemicals, Inc.).

These polysiloxane or fluorine type compounds are preferably added in an amount of 0.1% to 10% by mass, more preferably 1% to 5% by mass, based on the total solids content of the low refractive index layer.

The antireflection performance of the antireflective antiglare film having the low refractive index layer can be enhanced by providing a high refractive index layer between the antiglare layer and the low refractive index layer, which is on the side of the antiglare layer opposite to the transparent substrate, so that the optical inference by the low refractive index layer and that by the high refractive index layer are taken advantage of. Preferably, a medium refractive index layer the refractive index of which is intermediate between those of the low and high refractive index layers can be provided between the antiglare layer and the high refractive index layer. In what follows, the high refractive index layer, the medium refractive index layer, and the low refractive index layer will sometimes be inclusively referred to an “antireflective layer”. The terms “low”, “medium”, and “high” as used herein with respect to the refractive indices are relative terms that are used only in comparison to each other. The refractive indices of the low and the high refractive index layers preferably satisfy the following relationship with the refractive index of the transparent substrate: (1) transparent substrate>low refractive index layer; (2) high refractive index layer>transparent substrate.

In making the antireflective layer having a low refractive index layer overlying a high refractive index layer, the refractive index of the high refractive index layer is preferably 1.55 to 2.40, more preferably 1.60 to 2.20, even more preferably 1.60 to 2.00.

In making the antireflective layer having a medium refractive index layer, a high refractive index layer, and a low refractive index layer in the order described from the substrate side, the refractive index of the high refractive index layer is preferably 1.65 to 2.40, more preferably 1.70 to 2.20, and that of the medium refractive index layer is adjusted so as to be between those of the low and the high refractive index layers. Specifically, the refractive index layer of the medium refractive index layer is preferably 1.55 to 1.80, more preferably 1.55 to 1.70.

Exemplary and preferred inorganic particles that can be used in the high and the medium refractive index layers are particles composed mainly of inorganic oxides, such as TiO₂, ZrO₂, Al₂O₃, In₂O₃, ZnO, SnO₂, Sb₂O₃, and ITO. Inorganic particles composed mainly of SiO₂ may be added to adjust the refractive index. For use in the high refractive index layer, TiO₂ and ZrO₂ are preferred for obtaining a high refractive index. The inorganic particles may be surface treated with a silane coupling agent or titanium coupling agent. A surface treating agent introducing a functional group reactive with the binder species to the surface of the particles is preferably used.

The content of the inorganic particles in the high refractive index layer is preferably 10% to 90% by mass, more preferably 15% to 80% by mass, even more preferably 15% to 75% by mass. Two or more kinds of inorganic particles may be used in combination in the high refractive index layer.

In the cases where the low refractive index layer is formed on a high refractive index layer, it is preferred that the refractive index of the high refractive index layer be higher than that of the transparent substrate.

At least one of thin layers composing the antireflective layer can be designed to serve as an antistatic layer. It is possible in the present invention to form a low-refractive and highly stain-proof layer by using a fluorine-containing curing composition, particularly a fluorine-containing stain-proof agent. However, because fluorine is oriented in the skin of the layer, the layer has poor antistatic properties and tends to cause deterioration of dustproof properties. So, providing an independent antistatic layer is recommended in the invention to prevent static electrification on the film surface. Materials used to make an antistatic layer and the performance of an antistatic layer will be described hereunder.

An antistatic layer can be formed by any of conventional methods, including applying an electrically conductive (hereinafter, simply “conductive”) coating composition containing conductive fine particles and a reactive curing resin, applying a transparent conductive material containing a transparent, conductive polymer, and depositing or sputtering a transparent film-forming metal or metal oxide. An antistatic layer may be formed on a transparent substrate either directly or indirectly via a primer layer providing enhanced adhesion to the transparent substrate.

It is preferred that an antistatic layer be provided as a layer close to the outermost sublayer of the antireflective layer; for a sufficient antistatic effect will be produced even with a reduced layer thickness. It is preferred in the invention to use at least one sublayer of the antireflective layer as an antistatic layer or to provide an antistatic layer between a transparent substrate and the sublayer closest to the transparent layer of the antireflective layer. When the antistatic layer is formed by a wet coating process, the coating technique is not particularly limited and chosen as appropriate to the characteristics of the coating composition and the amount to be applied from known techniques, such as roller coating, gravure coating, bar coating, and extrusion coating.

The antistatic layer preferably has a surface resistivity (SR) satisfying formula: Log SR≧12. Log SR is more preferably 5 to 12, even more preferably 5 to 9, still more preferably 5 to 8. The surface resistivity (SR) of the antistatic layer is measured by the four-probe resistance method or the circular electrode method.

The antistatic layer is preferably substantially transparent. Specifically, the antistatic layer preferably has a haze of not more than 10%, more preferably 5% or less, even more preferably 3% or less, still more preferably 1% or less, and a light transmissivity of at least 50%, more preferably 60% or more, even more preferably 65% or more, still more preferably 70% or more, at a measurement wavelength of 550 nm.

As alluded to above, the antistatic layer can be formed by using a coating composition prepared by dispersing inorganic conductive particles and a reactive curing resin in a solvent (dispersing medium). The inorganic conductive particles are preferably formed of a metal oxide or nitride. Examples of the metal oxide or nitride include tin oxide, indium oxide, zinc oxide, and titanium nitride. Tin oxide and indium oxide are preferred. The conductive inorganic particles may contain the metal oxide or nitride as a main component and other elements. The term “main component” as used here means a component present in the particles at the highest proportion (percent by mass) of all the components of the particles. Examples of the other elements include Ti, Zr, Sn, Sb, Cu, Fe, Mn, Pb, Cd, As, Cr, Hg, Zn, Al, Mg, Si, P, S, B, Nb, In, V, and halogen atoms. To increase conductivity of tin oxide or indium oxide, addition of at least one of Sb, P, B, Nb, In, V, and halogen atoms is preferred. Specifically, at least one metal oxide selected from the group consisting of tin-doped indium oxide (ITO), antimony-doped tin oxide (ATO), fluorine-doped tin oxide (FTO), phosphorus-doped tin oxide (PTO), zinc antimonate (AZO), indium-doped zinc oxide (IZO), zinc oxide, ruthenium oxide, rhenium oxide, silver oxide, nickel oxide, and copper oxide is preferably used. More preferred of them are tin-doped indium oxide (IRO), antimony-doped tin oxide (ATO), and phosphorus-doped tin oxide (PTO). The Sb content in ATO is preferably 3% to 20% by mass, and the In content in ITO is preferably 5% to 20% by mass.

The inorganic conductive particles used to make the antistatic layer preferably have an average primary particle size of 1 to 150 nm, more preferably 5 to 100 nm, even more preferably 5 to 70 nm. The inorganic conductive particles in the antistatic layer preferably have an average particle size of 1 to 200 nm, more preferably 5 to 150 nm, even more preferably 10 to 100 nm, still more preferably 10 to 80 nm. The average particle size of the inorganic conductive particles is an average particle size with the mass of the particles taken as the weight, as measured by the light scattering method or on an electron micrograph.

The inorganic conductive particles may be surface treated with an organic or inorganic compound. Examples of the inorganic compound for surface treatment include alumina and silica, with silica being preferred. Examples of the organic compound for surface treatment include polyols, alkanolamines, stearic acid compounds, silane coupling agents, and titanate coupling agents, with silane coupling agents being particularly preferred. Specifically, the method described supra with respect to the surface treatment of the inorganic particles as component (C) is preferably followed. The method taught in JP-A-2008-31327, paras. [0101]-[0122] is also preferred. Two or more surface treatments may be carried out in combination.

The shape of the inorganic conductive particles is preferably rice grain-shaped, spherical, cubic, spindle-shaped, or amorphous.

A combination of two or more kinds of inorganic conductive particles may be used in the antistatic layer.

The inorganic conductive particles is preferably used in a proportion of 20% to 90% by mass, more preferably 25% to 85% by mass, even more preferably 30 to 80% by mass, based on the total solids content of the antistatic layer.

The inorganic conductive particles are used as dispersed in a dispersing medium to form the antistatic layer. Liquids having a boiling point of 60° to 170° C. are preferably used as a dispersing medium. Examples of such a dispersing medium include water, alcohols (e.g., methanol, ethanol, isopropyl alcohol, butanol, and benzyl alcohol), ketones (e.g., acetone, methyl ethyl ketone, methyl isobutyl ketone, and cyclohexanone), esters (e.g., methyl acetate, ethyl acetate, propyl acetate, butyl acetate, methyl formate, ethyl formate, propyl formate, and butyl formate), aliphatic hydrocarbons (e.g., hexane and cyclohexane), halogenated hydrocarbons (e.g. methylene chloride, chloroform, and carbon tetrachloride), aromatic hydrocarbons (e.g., benzene, toluene, xylene), amides (e.g., dimethylformamide, dimethylacetamide, and N-methylpyrrolidone), ethers (e.g., diethyl ether, dioxane, and tetrahydrofuran), and ether alcohols (e.g., 1-methoxy-2-propanol). Preferred of them are toluene, xylene, methyl ethyl ketone, methyl isobutyl ketone, cyclohexanone, and butanol. The inorganic conductive particles can be dispersed in the medium by using a dispersing machine. Exemplary and preferred dispersing machines are a sand grinder mill (e.g., a bead mill with pins), a high speed impeller mill, a pebble mill, a roller mill, an attritor, and a colloid mill. A sand grinder mill and a high speed impeller mill are more preferred. The particles may be subjected to preliminary dispersing using, for example, a ball mill, a three roll mill, a kneader, or an extruder.

It is preferred that the inorganic conductive particles be previously allowed to react with an alkoxysilane compound in an organic solvent. Using a reaction system obtained by the reaction between the inorganic conductive particles and the alkoxysilane compound provides an antistatic layer-forming coating composition with improved storage stability and curing properties.

Examples of commercially available products useful as the inorganic conductive particles include T-1 (ITO, from Mitsubishi Material Corp.), Pastran (ITO/ATO, from Mitsui Mining & Smelting Co., Ltd.), SN-100P (ATO, from Ishihara Sangyo Kaisha, Ltd.), Nano Tek ITO (from C.I. Kasei Co., Ltd.), and ATO and FTO (from Nissan Chemical Industries, Ltd.).

It is preferred to use conductive inorganic oxide particles having silicon oxide supported on the surface thereof; for such particles effectively react with an alkoxysilane compound. The conductive inorganic oxide particles having silicon oxide supported thereon are obtainable by, for example, the process disclosed in Japanese Patent 2858271, which includes forming a coprecipitate of tin oxide and antimony oxide hydrate, depositing a silicon compound thereon, classification, and sintering.

The conductive inorganic oxide particles having silicon oxide supported thereon are commercially available under the trade names of SN-100P (ATO) SNS-10M, and FSS-10M from Ishihara Sangyo Kaisha, Ltd.

Dispersions of the conductive inorganic oxide particles in an organic solvent are commercially available under the trade names of SNS-10M (antimony doped tin oxide in MEK) and FSS-10M (antimony doped tin oxide in isopropyl alcohol) from Ishihara Sangyo Kaisha, Ltd., trade names of Celnax CX-Z401M (zinc antimonate in methanol) and Celnax CX-Z200IP (zinc antimonate in isopropyl alcohol) from Nissan Chemical Industries, Ltd., and the trade name of ELCOM JX-1001PTV (phosphorus-containing tin oxide in propylene glycol monomethyl ether) from Catalysts & Chemicals Industries Co., Ltd.

As stated, the organic solvent used in the curing composition for the antistatic layer is used as a medium for dispersing the conductive inorganic oxide particles. The organic solvent is used in an amount preferably of 20 to 4000 parts by mass, more preferably 100 to 1000 parts by mass, per 100 parts by mass of the conductive inorganic oxide particles. Less than 20 parts of the solvent can result in too high a viscosity to allow for uniform reaction. More than 4000 parts of the solvent can result in reduction of coating properties.

Useful organic solvents are exemplified by those having a boiling point of 200° C. or lower at atmospheric pressure, including alcohols, ketones, ethers, esters, hydrocarbons, and amides. The solvents may be used either individually or as a mixture of two or more of them. Preferred of the solvents recited are alcohols, ketones, ethers, and esters.

Examples of the alcohols are methanol, ethanol, isopropyl alcohol, isobutanol, n-butanol, tert-butanol, ethoxyethanol, butoxyethanol, diethylene glycol monoethyl ether, benzyl alcohol, and phenethyl alcohol. Examples of the ketones are acetone, methyl ethyl ketone, methyl isobutyl ketone, and cyclohexanone. Examples of the ethers are dibutyl ether and propylene glycol monoethyl ether acetate. Examples of the esters are ethyl acetate, butyl acetate, and ethyl lactate. Examples of the hydrocarbons are toluene and xylene. Examples of the amides include formamide, dimethylacetamide, and N-methylpyrrolidone. Preferred of them are isopropyl alcohol, ethoxyethanol, butoxyethanol, diethylene glycol monoethyl ether, methyl ethyl ketone, methyl isobutyl ketone, cyclohexanone, propylene glycol monoethyl ether acetate, butyl acetate, and ethyl lactate.

The curing resins used in the high refractive index layer, particularly ionizing radiation-curing polyfunctional monomers or oligomers are preferably used as a binder of the antistatic layer. A crosslinked polymer obtained by the reaction of a reactive curing resin is also useful. The crosslinked polymer preferably has an anionic group.

The crosslinked polymer having an anionic group has such a structure that the main chain having an anionic group is crosslinked. The anionic group functions to maintain the dispersed state of the conductive inorganic particles. The crosslinked structure imparts film-forming ability to the polymer thereby functioning to strengthen the antistatic layer.

Examples of the polymer main chain include polyolefins (saturated hydrocarbons), polyethers, polyureas, polyurethanes, polyesters, polyamines, polyamides, and melamine resins. Preferred of them are polyolefin main chains, polyether main chains, and polyurea main chains. Polyolefin main chains and polyether main chains are more preferred. Polyolefin main chains are particularly preferred.

A polyolefin main chain is composed of a saturated hydrocarbon. A polyolefin main chain is obtained by, for example, addition polymerization of an unsaturated polymerizable group. A polyether main chain is composed of repeating units linked via an ether linkage (—O—) and is obtained by, for example, ring-opening polymerization of an epoxy group. A polyurea main chain is composed of repeating units linked via a urea linkage (—NH—CO—NH—) and is obtained by, for example, polycondensation of an isocyanate group and an amino group. A polyurethane main chain is composed of repeating units linked via a urethane linkage (—NH—CO—O—) and is formed by, for example, polycondensation of an isocyanate group and a hydroxyl group (inclusive of an N-methylol group). A polyester main chain is composed of repeating units linked via an ester linkage (—CO—O—) and is obtained by, for example, polycondensation between a carboxyl group (inclusive of an acid halide group) and a hydroxyl group (inclusive of an N-methylol group). A polyamine main chain is composed of repeating units linked via an imino linkage (—NH—) and is formed by, for example, ring-opening polymerization of an ethyleneimine group. A polyamide main chain is composed of repeating units linked via an amide linkage (—NH—CO—) and is obtained by, for example, reaction between an isocyanate group and a carboxyl group (inclusive of an acid halide group). A melamine resin main chain is obtained by, for example, polycondensation between a triazine group (e.g., melamine) and an aldehyde (e.g., formaldehyde). The main chain of the melamine resin has per se a crosslinked structure.

The anionic group is bonded to the polymer main chain directly or via a linking group. The anionic group is preferably bonded as a side chain to the main chain via a linking group.

Examples of the anionic group include a carboxyl group, a sulfo group, and a phosphono group, with a sulfo group and a phosphono group being preferred. The anionic group may be of a salt form. The cation forming a salt with the anionic group is preferably an alkali metal ion. The proton of the anionic group may be dissociated.

Exemplary preferred linking groups that link the anionic group and the polymer main chain include —CO—, —O—, an alkylene group, an arylene group, and a divalent group composed of two or more of these linking groups.

The crosslink structure chemically (preferably covalently) bonds two or more main chains to each other. The crosslink structure preferably covalently bonds three or more main chains to one another. The crosslink structure is preferably made of —CO—, —O—, —S—, a nitrogen atom, a phosphorus atom, an aliphatic residual group, an aromatic residual group, or a divalent or polyvalent group composed of two or more of these groups and atoms.

The crosslinked polymer having an anionic group is preferably a copolymer having a repeating unit with an anionic group and a repeating unit with a crosslink structure. The proportion of the repeating unit with an anionic group in the copolymer is preferably 2% to 96%, more preferably 4% to 94%, even more preferably 6% to 92%, by mass. This repeating unit may have two or more anionic groups. The proportion of the repeating unit with a crosslink structure in the copolymer is preferably 4% to 98% more preferably 6% to 96%, even more preferably 8% to 94%, by mass.

The crosslinked polymer having an anionic group may be made up of a repeating unit having both an anionic group and a crosslink structure and may contain other repeating unit(s) having neither an anionic group nor a crosslink structure. Examples of suitable other repeating units are a unit having an amino group or a quaternary ammonium group and a unit having a benzene ring. The amino and the quaternary ammonium group function to maintain the dispersed state of the inorganic particles similarly to the anionic group. The amino group, the quaternary ammonium group, and the benzene ring may be present in the anionic group-containing repeating unit or the crosslink structure-containing repeating unit to produce the same effects.

The amino group- or quaternary ammonium group-containing repeating unit has the amino or quaternary ammonium group bonded directly to the polymer main chain or via a linking group. The amino or quaternary ammonium group is preferably bonded to the main chain via a linking group as a side chain. The amino group or the quaternary ammonium group is preferably a secondary amino group, a tertiary amino group, or a quaternary ammonium group, and more preferably a tertiary amino group or a quaternary ammonium group. The group bonded to the nitrogen atom of the secondary or tertiary amino group or the quaternary ammonium group is preferably an alkyl group, more preferably an alkyl group with 1 to 12 carbon atoms, particularly preferably an alkyl group with 1 to 6 carbon atoms. The counter ion of the quaternary ammonium group is preferably a halide ion. The linking group between the polymer main chain and the amino or quaternary ammonium group is preferably —CO—, —NH—, —O—, an alkylene group, an arylene group, or a divalent group composed of two or more of the linking groups recited. When the crosslinked polymer having an anionic group contains a repeating unit having an amino or quaternary ammonium group, the proportion of that repeating unit is preferably 0.06% to 32%, more preferably 0.08 to 30%, even more preferably 0.1% to 28%, by mass.

The above described binder may be used in combination with a reactive organosilicon compound such as the one described in JP-A-2003-39586. The reactive organosilicon compound can be used in an amount of 10% to 70% by mass based on the ionizing radiation-curing resin as a binder. An exemplary preferred reactive organosilicon compound is an organosilane compound, which is possibly used as a sole resin component for forming an antistatic layer.

The solvents that are preferably used to prepare a coating composition forming any layer other than the antistatic layer include alcohols and ketones, the examples of which are acetone, methyl ethyl ketone, 2-pentanone, 3-pentanone, 2-hexane, 2-heptanone, 4-heptanone, methyl isopropyl ketone, ethyl isopropyl ketone, diisopropyl ketone, methyl isobutyl ketone, methyl t-butyl ketone, diacetyl, acetylacetone, acetonylacetone, diacetone alcohol, mesityl oxide, chloroacetone, cyclopentanone, cyclohexanone, and acetophenone. Methyl ethyl ketone and methyl isobutyl ketone are preferred of them. These solvents may be used either individually or as a mixture thereof at any mixing ratio.

Auxiliary solvents may be used appropriately, including esters (e.g., propylene glycol monomethyl ether acetate) or fluorine-containing solvents (e.g., fluoroalcohols). These auxiliary solvents may also be used individually or as a mixture at any mixing ratio.

It is preferred that the antireflective antiglare film of the invention, which includes the antireflective layer, have an integrated reflectance of 3.5% or less, more preferably 3.0% or less, even more preferably 2.0% or less, still more preferably 0.3 to 2.0%. An optical film with a so reduced integrated reflectance provides sufficient antiglare performance even with reduced light scattering on the film surface. As a result, antireflective antiglare film providing excellent depth of blacks can be obtained.

The transparent substrate of the optical film of the invention is preferably a plastic film. Polymers forming a plastic film substrate include cellulose acylates (e.g., cellulose triacetate and cellulose diacetate, typically TAC-TD80U and TD80UF from Fuji Film Corp.), polyamides, polycarbonates, polyesters (e.g., polyethylene terephthalate and polyethylene naphthalate), polystyrenes, polyolefins, norbornene resins (e.g., Arton from JSR Corp.), amorphous polyolefins (e.g., Zeonex from Nippon Zeon Co., Ltd.), and (meth)acrylic resins (e.g., Acrypet from Mitsubishi Rayon Co., Ltd. and the cyclic structure-containing acrylic resins described in JP-A-2004-70296 and JP-A-2006-171464). Preferred of them are cellulose triacetate, polyethylene terephthalate, and polyethylene naphthalate. Cellulose triacetate is particularly suited.

When the optical film of the invention is applied to an LCD, it is disposed as the outermost surface of the display by, for example, providing a pressure sensitive adhesive layer on one side thereof. The optical film may be combined with a polarizing plate. When the transparent substrate of the optical film is cellulose triacetate, because the protective film for a polarizer of the polarizing plate is usually a cellulose triacetate film, the optical film of the invention serves as a protective film of the polarizer, which is economically advantageous.

In the case where the optical film of the invention is disposed on the outermost surface of a display via, for example, a pressure sensitive adhesive layer, or used as such as a polarizer protective film, it is preferred that the transparent substrate having all the layers up to the outermost layer provided thereon be subjected to saponification treatment so achieve sufficient adhesion. The saponification treatment is carried out in a known manner, for example, by immersion in an alkaline solution for a proper time of period. After the treatment, the film is freed of any residual alkali component by, fox example, thoroughly washing with water or soaking in a dilute acid to neutralize the alkali component. The saponification treatment hydrophilizes the exposed side of the transparent substrate, the side opposite to the outermost layer.

The optical film of the invention is required to provide both excellent antiglare properties and depth of blacks. Regarding antiglare properties, the optical film should exhibit satisfactory antiglare performance in practice in various situations in which light from various sources enters the display device at various incident angles. As a result of extensive investigations, the present inventors have found that reflections under such various situations of ambient and image light can conveniently be evaluated by changing the expected angle of incident light. Good reflection of light should be produced using both a large sized light source (e.g., a fluorescent lamp) and a slit-shaped light source (a linear light source made by partly covering a fluorescent lamp). Regarding depth of blacks, the optical film should exhibit satisfactory depth of blacks when viewed from the direction vertical to the display and a direction at an angle of about 45° from that direction both in a bright environment. It has been proved that the optical film should have a specific surface profile while satisfying the above specified film thickness condition in order to achieve both excellent antiglare properties and depth of blacks when evaluated based on these criteria. The aforementioned preferred ranges of size, reflectance, etc. of particles are essential factors for achieving the specific surface profile. The specific surface profile of the optical film as referred to above are then described.

The antiglare film of the invention preferably has a centerline average roughness (centerline roughness average) Ra of 0.05 to 0.25 μm, more preferably 0.10 to 0.20 μm. With too large Ra, the optical film can have poor black levels and poor display contrast in bright lighting. With too small Ra, the film has reduced antiglare properties. The ten point height parameter Rz of the optical film of the invention is preferably not more than 10 times the Ra.

To attain a surface profile suited to satisfy both the requirements for antiglare performance and depth of blacks, a mean spacing between profile peaks at the mean line (Sm) is also of importance. Sm is preferably 60 to 150 μm, more preferably 60 to 140 μm, even more preferably 70 to 140 μm. An optical film with too large Sm has a rough surface and a poor appearance, and reflection of a large light source on the display becomes noticeable. An optical film with too small Sm provides poor depth of blacks and is less effective in blurring the edge of a reflected image of a slit light source (line light source).

In order to improve display contrast in bright lighting, it is necessary to control the average slope of angle (θa) of the surface profile of the optical film at the same time. The average slope is preferably 0.5° to 3.0°, more preferably 0.7° to 2.0°. At too large a slope, the depth of blacks deteriorates, and the optical film is less effective in blurring the edge of a reflected image of a slit light source (line light source). At too small a slope, reflection of a large light source on the display becomes noticeable.

The peak slope (θp) in the slope distribution of the profile is also very important for achieving both excellent antiglare performance and depth of blacks as aimed at in the present invention. θp is preferably 0.05° to 0.50°, more preferably 0.05° to 0.30°. Too small θₚ makes reflection of a large size light source conspicuous. Too large θp deteriorates depth of blacks and lessens the edge blur of a reflected image of a slit light source (line light source).

The average slope of the optical film is determined as follows. Vertices of an imaginary triangle with an area of 0.5 to 2 μm² are placed on the transparent substrate. A vertical line is drawn upward from each vertex. The three intersections of the vertical lines with the film surface make a triangle. The angle formed between the normal to the plane of the triangle on the film surface and the vertical to the substrate is taken as the slope of the film surface. An measurement area of at least 250,000 μm² (0.25 mm²) of the substrate is divided into the imaginary triangles, and measurement is taken on each of them to obtain an average slope.

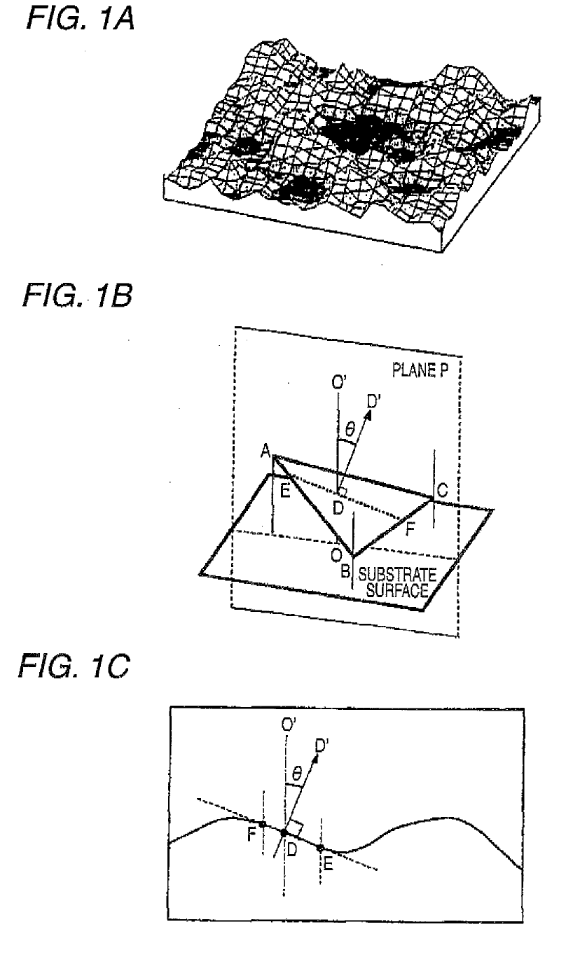

The measurement of the slope will be described in more detail with reference to FIGS. 1A to 1C. The optical film to be assessed is divided into meshes each having an area ranging from 0.5 to 2 μm² as illustrated in FIG. 1A. FIG. 1B shows selected three points in one of the meshes. Vertical lines extending upward from the three points intersect with the film surface at A, B, and C. The normal DD′ to the triangle ABC and the normal OO′ to the substrate make an angle θ, which is taken as a slope FIG. 1C is a cross-section of the film cut along plane P containing points O′DD′. Segment EF is a line of intersection between the triangle ABC and the plane P. The measurement area is preferably at least 250,000 μm² (0.25 mm²) on the substrate, which is divided into triangles on the substrate, each of which is measured for slope. While several instruments are available for the measurement, exemplary is SXM520-AS150 from Micromap Corp. (USA). In the case of using SXM520-AS150, when the objective lens has a magnification of 10×, the unit measurement area of slope measurement is 0.8 μm² and the total measurement area is 500,000 μm² (0.5 mm²). The unit area and the measurement area decrease with an increase of the magnification times of the objective lens. The measured data are analyzed using software such as MAT-LAB to calculate the slope distribution, from which an average slope is calculated.

The antiglare film of the invention preferably has a surface haze (a haze due to surface light scattering) of 0.2% to 10%, more preferably 0.2% to 5%. Too high a surface haze deteriorates depth of blacks. Too low a surface haze results in deteriorated antiglare properties.

The antiglare film of the invention preferably has an internal haze (a haze due to internal light scattering) of 1 to 40%, more preferably 5% to 30%, even more preferably 10% to 25%. Too high an internal haze causes reduction in front contrast, resulting in a whitish image. An optical film with an internal haze lower than 1% involves production problems, such as reduced freedom of choice of materials, difficulty in designing desired antiglare performance and other characteristics in good balance, and increased cost.

The surface haze and the internal haze of the antiglare film are measured according to the following procedure.
(1) The total haze (H) of the optical film is measured in accordance with JIS K7136.
(2) The film is sandwiched between a pair of 1 mm thick microslide glass plates (S9111 from Matsunami Glass Ind., Ltd.) with a few drops of silicone oil spread between each side of the film and the glass plate so as to achieve complete optical contact and thereby to eliminate a surface haze. In this state, the haze of the specimen is measured. Separately, the same glass plates are joined with silicon oil spread therebetween to make a control specimen. The difference of the measured haze values (of the film and the control) is taken as an internal haze (Hi) of the film.
(3) The internal haze (Hi) as calculated in (2) above is subtracted from the total haze (H) measured in (1) above to give a surface haze (Hs) of the film.

The antiglare film of the invention preferably achieves an image clarity of 30% to 99%, more preferably 40% to 95%, even more preferably 50% to 90%, still more preferably 60% to 80%, as measured in accordance with JIS K7105 at an optical comb width of 0.5 mm. A lower image clarify leads to deteriorated display contrast in bright lighting, and a higher image clarify leads to deteriorated antiglare properties.

The optical film of the invention is produced by, for example, by the following method, which is described for illustrative purposes only but not for limitation.

Coating compositions for various functional layers are prepared from the respective components. The coating compositions are successively applied to a transparent substrate and dried by heating. Suitable coating techniques include dip coating, air knife coating, curtain coating, roller coating, wire bar coating, gravure coating, and die coating. Microgravure coating, wire bar coating, and die coating (see U.S. Pat. No. 2,681,294 or JP-A-2006-122889) are preferred. Die coating is the most suitable technique.

The coating layer thus provided is irradiated with light or heated to induce polymerization of the monomer to cure the layer, whereby an intended functional layer is formed. The functional layer may have two or more sublayers.

Similarly, a coating composition providing a low refractive index layer is applied to the functional layer and cured by irradiation with an ionizing radiation, such as UV light, or heating to form a low refractive index layer. The curing is preferably affected by irradiating with an ionizing radiation under heating. The optical film of the present invention is thus produced.

A polarizing plate basically includes a polarizer and two protective films each protecting either side of the polarizer. The optical film of the invention is preferably used as at least one of the protective films. Production cost for a polarizing plate can be reduced by using the optical film of the invention serving for both antiglare performance and protection of a polarizer. Being disposed as the outermost layer, the optical film of the invention provides a polarizing plate that prevents reflection of ambient light and exhibits excellent scratch resistance and stain-proof properties.

The optical film of the invention having its surface hydrophilized is stuck to a polarizer with a polyvinyl alcohol adhesive to provide a polarizing plate. Saponification is a preferred hydrophilization treatment. The hydrophilization treatment is particularly effective for the improvement of adhesion to a polarizer having polyvinyl alcohol as a main component. Additionally, a hydrophilized surface is more resistant against adhesion of dust in air. Therefore, dust is prevented from entering between the polarizer and the optical film when they are joined to each other. This is effective in preventing spots (defect) due to dust entrapment.

The saponification treatment is preferably carried out so that the side of the transparent substrate opposite to the outermost layer side may have a water contact angle of 40° or smaller, more preferably 30° or smaller, even more preferably 20° or smaller.

The optical film of the invention is applicable to image display devices including LCDs, PDPs, ELDs, CRTs, and surface-conduction electron-emitter displays (SEDs). It is particularly suited for use in LCDs. Having a transparent substrates the optical film is used as stuck to the front side of a display device on its transparent substrate side. When applied to an LCD, the optical film is processed to make a polarizing plate, which is bonded to the front side of an LCD with the optical film of the invention facing out.

In the case when the optical film of the invention is used as a protective film on one side of a polarizer, it is preferably used in transmissive, reflective, or semi-transmissive LCDs of various modes, including twisted nematic (TN), supertwisted nematic (STN), vertical alignment (VA), in-plain switching (IPS), and optically compensated bend (OCB).

### EXAMPLES

The present invention will now be illustrated in greater detail with reference to Examples, but it should be understood that the invention is not construed as being limited thereto. Unless otherwise noted, all the parts and percents are by mass.

### Coating Composition A-1 for Antiglare Layer:

| | |
|---|---|
| PET-30 | 74.8 g |
| DPHA | 13.2 g |
| Irgacure 127 | 3.0 g |
| Dispersion (30%) of 6 μm, crosslinked | 26.4 g |
| acrylate/styrene copolymer particles A | |
| SP-13 | 0.2 g |
| MIBK | 22.0 g |
| MEK | 40.4 g |

### Coating Composition A-2 for Antiglare Layer:

| | | |
|---|---|---|
| PET-30 | 71.4 | g |
| DPHA | 12.6 | g |
| Irgacure 127 | 3.0 | g |
| Dispersion (30%) of 6 μm crosslinked | 26.4 | g |
| acrylate/styrene copolymer particles A | | |
| Dispersion (30%) of 6 μm | 13.2 | g |
| crosslinked polyacrylate | | |
| particles B | | |
| SP-13 | 0.2 | g |
| MIBK | 12.8 | g |
| MEK | 40.4 | g |

### Coating Composition A-3 for Antiglare Layer:

| | |
|---|---|
| PET-30 | 71.4 g |
| DPHA | 12.6 g |
| Irgacure 127 | 3.0 g |
| Dispersion (30%) of 7 μm crosslinked | 26.4 g |
| acrylate/styrene copolymer particles C | |
| Dispersion (30%) of 7 μm crosslinked polyacrylate | 13.2 g |
| particles D | |
| SP-13 | 0.2 g |
| MIBK | 12.8 g |
| MEK | 40.4 g |

### Coating Composition A-4 for Antiglare Layer:

| | | |
|---|---|---|
| PET-30 | 71.4 | g |
| DPHA | 12.6 | g |
| Irgacure 127 | 3.0 | g |
| Dispersion (30%) of 8 μm crosslinked | 26.4 | g |
| acrylate/styrene copolymer particles E | | |
| Dispersion (30%) of 8 μm crosslinked polyacrylate | 13.2 | g |
| particles F | | |
| SP-13 | 0.2 | g |
| MIBK | 12.8 | g |
| MEK | 40.4 | g |

### Coating Composition A-5 for Antiglare Layer:

| | | |
|---|---|---|
| PET-30 | 70.6 | g |
| DPHA | 12.5 | g |
| Irgacure 127 | 3.0 | g |
| Dispersion (30%) of 6 μm crosslinked | 33.0 | g |
| acrylate/styrene copolymer particles G | | |
| Dispersion (30%) of 6 μm crosslinked polyacrylate | 9.9 | g |
| particles B | | |
| SP-13 | 0.2 | g |
| MIBK | 10.5 | g |
| MEK | 40.4 | g |

### Coating Composition A-6 for Antiglare Layer:

| | | |
|---|---|---|
| PET-30 | 74.0 | g |
| DPHA | 13.1 | g |
| Irgacure 127 | 3.0 | g |
| Dispersion (30%) of 6 μm crosslinked | 19.8 | g |
| acrylate/styrene copolymer particles H | | |
| Dispersion (30%) of 6 μm crosslinked polyacrylate | 9.9 | g |
| particles B | | |
| SP-13 | 0.2 | g |
| MIBK | 19.7 | g |
| MEK | 40.4 | g |

### Coating Composition A-7 for Antiglare Layer:

| | | |
|---|---|---|
| PET-30 | 71.4 | g |
| DPHA | 12.6 | g |
| Irgacure 127 | 3.0 | g |
| Dispersion (30%) of 6 μm crosslinked | 23.1 | g |
| acrylate/styrene copolymer particles A | | |
| Dispersion (30%) of 6 μm crosslinked polyacrylate | 16.5 | g |
| particles B | | |
| SP-13 | 0.2 | g |
| MIBK | 12.8 | g |
| MEK | 40.4 | g |

### Coating Composition A-8 for Antiglare Layer:

| | | |
|---|---|---|
| PET-30 | 74.8 | g |
| DPHA | 13.2 | g |
| Irgacure 127 | 3.0 | g |
| Dispersion (30%) of 6 μm crosslinked polystyrene | 26.4 | g |
| particles I | | |
| SP-13 | 0.2 | g |
| MIBK | 22.0 | g |
| MEK | 40.4 | g |

### Coating Composition A-9 for Antiglare Layer:

| | | |
|---|---|---|
| PET-30 | 74.8 | g |
| DPHA | 13.2 | g |
| Irgacure 127 | 3.0 | g |
| Dispersion (30%) of 6 μm crosslinked polystyrene | 26.4 | g |
| particles J | | |
| SP-13 | 0.2 | g |
| MIBK | 22.0 | g |
| MEK | 40.4 | g |

### Coating Composition A-10 for Antiglare Layer:

| | | |
|---|---|---|
| PET-30 | 74.8 | g |
| DPHA | 13.2 | g |
| Irgacure 127 | 3.0 | g |
| Dispersion (30%) of 6 μm crosslinked | 26.4 | g |
| acrylate/styrene copolymer particles K | | |
| SP-13 | 0.2 | g |
| MIBK | 22.0 | g |
| MEK | 40.4 | g |

### Coating Composition A-11 for Antiglare Layer:

| | | |
|---|---|---|
| PET-30 | 71.4 | g |
| DPHA | 12.6 | g |
| Irgacure 127 | 3.0 | g |
| Dispersion (30%) of 5 μm crosslinked | 26.4 | g |
| acrylate/styrene copolymer particles L | | |
| Dispersion (30%) of 5 μm crosslinked polyacrylate | 13.2 | g |
| particles M | | |
| SP-13 | 0.2 | g |
| MIBK | 12.8 | g |
| MEK | 40.4 | g |

### Coating Composition A-12 for Antiglare Layer:

| | | |
|---|---|---|
| PET-30 | 71.4 | g |
| DPHA | 12.6 | g |
| Irgacure 127 | 3.0 | g |
| Dispersion (30%) of 3.5 μm crosslinked | 26.4 | g |
| acrylate/styrene copolymer particles N | | |
| Dispersion (30%) of 3.5 μm crosslinked | 13.2 | g |
| polyacrylate particles O | | |
| SP-13 | 0.2 | g |
| MIBK | 12.8 | g |
| MEK | 40.4 | g |

### Coating Composition A-13 for Antiglare Layer;

| | | |
|---|---|---|
| PET-30 | 71.4 | g |
| DPHA | 12.6 | g |
| Irgacure 127 | 3.0 | g |
| Dispersion (30%) of 12 μm crosslinked | 26.4 | g |
| acrylate/styrene copolymer particles P | | |
| Dispersion (30%) of 12 μm crosslinked polyacrylate | 13.2 | g |
| particles Q | | |
| SP-13 | 0.2 | g |
| MIBK | 12.8 | g |
| MEK | 40.4 | g |

### Coating Composition A-14 for Antiglare Layer:

| | | |
|---|---|---|
| PET-30 | 72.3 | g |
| DPHA | 12.8 | g |
| Irgacure 127 | 3.0 | g |
| Dispersion (30%) of 6 μm crosslinked | 29.7 | g |
| acrylate/styrene copolymer particles H | | |
| Dispersion (30%) of 6 μm crosslinked polyacrylate | 6.6 | g |
| particles B | | |
| SP-13 | 0.2 | g |
| MIBK | 15.1 | g |
| MEK | 40.4 | g |

### Coating Composition A-15 for Antiglare Layer:

| | | |
|---|---|---|
| PET-30 | 73.1 | g |
| DPHA | 12.9 | g |
| Irgacure 127 | 3.0 | g |
| Dispersion (30%) of 6 μm crosslinked | 33.0 | g |
| acrylate/styrene copolymer particles H | | |
| SP-13 | 0.2 | g |
| MIBK | 17.4 | g |
| MEK | 40.4 | g |

### Coating Composition A-16 for Antiglare Layer:

| | | |
|---|---|---|
| PET-30 | 46.8 | g |
| DPHA | 46.8 | g |
| Irgacure 127 | 3.3 | g |
| Dispersion (30%) of 6 μm crosslinked polyacrylate | 6.0 | g |
| particles B | | |
| Dispersion (30%) of 6 μm crosslinked | 24.2 | g |
| acrylate/styrene copolymer particles A | | |
| SP-13 | 0.3 | g |
| MIBK | 42.1 | g |
| MEK | 27.8 | g |
| CAB-531-1 (20% MEK solution) | 27.8 | g |

Each of the coating compositions for antiglare layer was filtered through a polypropylene filter having a pore size of 30 μm.

The dispersions of particles used in the coating compositions were prepared by slowly adding the particles below to MIBK while stirring until the solid concentration reached 40%. After completion of the addition, the stirring was continued for 30 minutes. All the particles used were purchased from Sekisui Plastics Co., Ltd.
Crosslinked acrylate/styrene copolymer particles A (6 μm): refractive index=1.56; acrylate/styrene=3/7)
Crosslinked polyacrylate particles B: refractive index=1.49
Crosslinked acrylate/styrene copolymer particles C (7 μm): refractive index=1.56; acrylate/styrene=3/7
Crosslinked polyacrylate particles D (7 μm): refractive index=1.49
Crosslinked acrylate/styrene copolymer particles E (8 μm): refractive index=1.56; acrylate/styrene=3/7
Crosslinked polyacrylate particles F (8 μm): refractive index=1.49
Crosslinked acrylate/styrene copolymer particles G (6 μm): refractive index=1.56; acrylate/styrene=4/6
Crosslinked acrylate/styrene copolymer particles H (6 μm): refractive index=1.57; acrylate/styrene=2/8
Crosslinked polystyrene particles I (6 μm): refractive index=1.59
Crosslinked polyacrylate particles J (6 μm) refractive index=1.49
Crosslinked acrylate/styrene copolymer particles K (6 μm): refractive index=1.54; acrylate/styrene=5/5
Crosslinked acrylate/styrene copolymer particles L (5 μm): refractive index=1.56; acrylate/styrene=3/7
Crosslinked polyacrylate particles M (5 μm): refractive index=1.49
Crosslinked acrylate/styrene copolymer particles N (3.5 μm): refractive index=1.56; acrylate/styrene=3/7
Crosslinked polyacrylate particles O (3.5 μm): refractive index=1.49
Crosslinked acrylate/styrene copolymer particles P (12 μm): refractive index=1.56; acrylate/styrene=3/7
Crosslinked polyacrylate particles (12 μm): refractive index=1.49

The refractive index of cured products made from the coating compositions having the above described components except the particles A and B was measured with an Abbe refractometer. The refractive indices of the cured films of coating compositions A-1 to A-15 from which particles were removed ranged from 1.520 to 1.530. The refractive index of the cured film of coating composition A-16 from which particles were removed was 1.515.

### Coating Composition L-1 for Low Refractive Index Layer:

| | | |
|---|---|---|
| Ethylenically unsaturated group-containing | 3.9 | g |
| fluoropolymer (A-1) | | |
| Silica dispersion A (22%) | 25.0 | g |
| Irgacure 127 | 0.2 | g |
| DPHA | 0.4 | g |
| MEK | 100.0 | g |
| MIBK | 45.5 | g |

### Coating Composition L-2 for Low Refractive Index Layer:

| | | |
|---|---|---|
| Ethylenically unsaturated group-containing | 3.9 | g |
| fluoropolymer (A-1) | | |
| Silica dispersion B-1 (28%) | 8.5 | g |
| Silica dispersion B-2 (28%) | 11.1 | g |
| Irgacure 127 | 0.2 | g |
| PET-30 | 0.4 | g |
| MEK | 104.4 | g |
| MIBK | 45.5 | g |

Each of the coating compositions for low refractive index layer was filtered through a polypropylene filter having a pore size of 20 μm. The refractive indices of cured films (low refractive index layers) of coating compositions L-1 and L-2 were 1.36 and 1.45, respectively.

Components used in the coating compositions were as follows.
PET-30: Mixture of pentaerythritol triacrylate and pentaerythritol tetraacrylate, available from Nippon Kayaku Co., Ltd.
DPHA: Mixture of dipentaerythritol pentaacrylate and dipentaerythritol hexaacrylate, available from Nippon Kayaku Co., Ltd.
Irgacure 127: Polymerization initiator, from Ciba Specialty Chemicals
Ethylenically unsaturated group-containing fluoropolymer (A-1): Fluoropolymer (A-1) described in Preparation Example 3 of JP-A-2005-89536.
CAB-531-1: Cellulose acylate butyrate, available from Eastman Chemical Company.
SP-13: Fluorine-containing surface active agent of formula shown below (molecular weight: 14000), used as a 40% solution in MEK

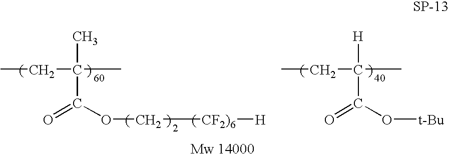

### Silica Dispersion A:

Hollow silica sol in IPA (average particle size: 60 nm; shell thickness; 10 nm; silica concentration: 20%; refractive index of silica particles: 1.31) was prepared in accordance with the procedure of Preparation Example 4 of JP-A-2002-79616, except for altering the size. To 500 g of the hollow silica sol were added 10 g of acryloyloxypropyltrimethoxysilane (from Shin-Etsu Chemical Co., Ltd.) and 1.0 g of diisopropoxyalumninum ethyl acetate and mixed. To the mixture was further added 3 g of ion exchanged water. The mixture was caused to react at 60° C. for 8 hours. After cooling to room temperature, 1.0 g of acetylacetone was added to the reaction system. A 500 g portion of the resulting dispersion was subjected to solvent displacement by distillation under reduced pressure while adding cyclohexanone at such a rate as to keep a constant silica concentration. Foreign matter production was not observed in the resulting dispersion. The solid concentration was adjusted to 22% with cyclohexanone, at which concentration the viscosity was 5 mPa·s at 25° C. The residual amount of IPA in the resulting silica dispersion A was found to be 1.0% as a result of gas chromatography.

### Silica Dispersion B-1:

To 500 g of MEK-ST-L (colloidal silica dispersion in MEK available from Nissan Chemical; silica concentration: 30%; average particle size: 45 nm) were added 10 g of acryloyloxypropyltrimethoxysilane (from Shin-Etsu Chemical) and 1.0 g of diisopropoxyaluminum ethyl acetate and mixed. To the mixture was further added 3 g of ion exchanged water. The mixture was caused to react at 60° C. for 8 hours. After cooling to room temperature, 1.0 g of acetylacetone was added to the reaction system. Foreign matter production was not observed in the resulting dispersion. The solid concentration was adjusted to 28% with MEK, at which concentration the viscosity was 1 mPa·s at 25° C.

### Silica Dispersion B-2:

To 500 g of MEK-ST (colloidal silica dispersion in MEK available from Nissan Chemical; silica concentration: 30%; average particle size: 15 nm) were added 10 g of acryloyloxypropyltrimethoxysilane (from Shin-Etsu Chemical) and 1.0 g of diisopropoxyaluminum ethyl acetate and mixed. To the mixture was further added 3 g of ion exchanged water. The mixture was caused to react at 60° C. for 8 hours. After cooling to room temperature, 1.0 g of acetylacetone was added to the reaction system. Foreign matter production was not observed in the resulting dispersion. The solid concentration was adjusted to 28% with MEK, at which concentration the viscosity was 1.5 mPa·s at 25° C.

### Example 1

### Preparation of Optical Film Samples 101 to 121

### (1) Formation of Antiglare Layer

The coating composition for antiglare layer shown in Table 1 below was applied to a web of 80 μm thick triacetyl cellulose film (TAC-TD80U, from Fuji Film Corp.) fed from a roll at a rate of 30 m/min by die coating using the slot die described in Example 1 of JP-A-2006-122889, dried at 60° C. for 150 seconds, and cured by irradiation with UV light from a 160 W/cm air cooled metal halide lamp (from Eye Graphics Co., Ltd.) at an illuminance of 400 mW/cm² and an irradiation dose of 100 mJ/cm² in an nitrogen-purged atmosphere with an oxygen concentration of about 0.1% by volume. The resulting coated web was taken up in roll form. The amount of the coating composition applied was adjusted to result in the antiglare film thickness shown in Table 1.

TABLE 1

| | | | | | | Particle | | | | |
|---|---|---|---|---|---|---|---|---|---|---|
| | | | | | | Content | | Coating | | |
| | | | | | Particle | A/B in | Antiglare | Composition | | |
| | | | Particle | Particle | Refractive | Total | Film | for | | |
| Sample | | | Size dA | Size dB | Index | Solids | Thickness | Antiglare | | |
| No. | Particles A | Particles B | (μm) | (μm) | npA/npB | (wt %) | (μm) | Layer | dA/t | Remark |
| 101 | A | — | 6 | — | 1.56 | 8/0 | 14 | A-1 | 0.43 | invention |
| 102 | A | B | 6 | 6 | 1.56/1.49 | 8/4 | 14 | A-2 | 0.43 | invention |
| 103 | C | D | 7 | 7 | 1.56/1.49 | 8/4 | 14 | A-3 | 0.50 | invention |
| 104 | E | F | 8 | 8 | 1.56/1.49 | 8/4 | 14 | A-4 | 0.57 | invention |
| 105 | G | B | 6 | 6 | 1.55/1.49 | 10/3 | 14 | A-5 | 0.43 | invention |
| 106 | H | B | 6 | 6 | 1.57/1.49 | 6/3 | 14 | A-6 | 0.43 | invention |
| 107 | A | B | 6 | 6 | 1.56/1.49 | 7/5 | 10 | A-7 | 0.60 | invention |
| 108 | I | — | 6 | — | 1.59 | 8/0 | 14 | A-8 | 0.43 | comparison |
| 109 | J | — | 6 | — | 1.49 | 8/0 | 14 | A-9 | 0.43 | comparison |
| 110 | K | — | 6 | — | 1.54 | 8/0 | 14 | A-10 | 0.43 | comparison |
| 111 | L | M | 5 | 5 | 1.56/1.49 | 8/4 | 14 | A-11 | 0.36 | comparison |
| 112 | N | O | 3.5 | 3.5 | 1.56/1.49 | 8/4 | 14 | A-12 | 0.25 | comparison |
| 113 | P | Q | 12 | 12 | 1.56/1.49 | 8/4 | 14 | A-13 | 0.86 | comparison |
| 114 | A | B | 6 | 6 | 1.56/1.49 | 7/5 | 7 | A-7 | 0.86 | comparison |
| 115 | A | B | 6 | 6 | 1.56/1.49 | 8/4 | 22 | A-2 | 0.27 | comparison |
| 116 | H | B | 6 | 6 | 1.57/1.49 | 9/2 | 14 | A-14 | 0.43 | invention |
| 117 | H | — | 6 | — | 1.57 | 10/0 | 14 | A-15 | 0.43 | invention |
| 118 | A | B | 6 | 6 | 1.56/1.49 | 6.8/1.7 | 8.5 | A-16 | 0.71 | invention |
| 119 | A | B | 6 | 6 | 1.56/1.49 | 6.8/1.7 | 11 | A-16 | 0.55 | invention |
| 120 | A | B | 6 | 6 | 1.56/1.49 | 6.8/1.7 | 14 | A-16 | 0.44 | invention |

### (2) Formation of Low Refractive Index Layer

The coated web was unrolled, and the coating composition L-1 for low refractive index layer was applied on the antiglare layer by die coating using the same slot die as used above at a film feed rate of 30 m/min, dried at 90° C. for 75 seconds, and cured by irradiation with UV light from a 240 W/cm air cooled metal halide lamp (from Eye Graphics Co., Ltd. ) at an illuminance of 400 mW/cm² and an irradiation dose of 240 mJ/cm² in an nitrogen-purged atmosphere with an oxygen concentration of 0.01% to 0.1% by volume to form a low refractive index layer having a thickness of 100 nm. The resulting coated web was taken up in roll form to obtain antireflective antiglare film samples 101 to 120. The same procedure as for antireflective antiglare film sample 119 was repeated, except for replacing coating composition L-1 for low refractive index layer with coating composition L-2, to make antireflective antiglare film sample 121.

### (3) Saponification Treatment

A 1.5 mol/l aqueous solution of sodium hydroxide was prepared and maintained at 55° C. A 0.01 mol/l dilute sulfuric acid aqueous solution was prepared and maintained at 35° C.

Each of the film samples prepared above was immersed in the sodium hydroxide aqueous solution for 2 minutes and then in water to thoroughly wash away the sodium hydroxide aqueous solution. Each of the films was then immersed in the dilute sulfuric acid aqueous solution for 1 minute and then in water to thoroughly wash way the sulfuric acid aqueous solution. Finally, the film was thoroughly dried at 120° C. to make saponified optical films (sample Nos. 101 to 107 and 116 to 121 according to the invention and comparative sample No. 108 to 115).

### (4) Making of Polarizing Plate

A polarizer (an iodine-stained polyvinyl alcohol stretched film) was sandwiched between the triacetyl cellulose film side of the saponified optical film prepared above and an 80 μm thick triacetyl cellulose film (TAC-TD80U, from Fuji Film) having been immersed in a 1.5 mol/l aqueous sodium hydroxide solution kept at 55° C., followed by neutralization and washing with water.

### (5) Evaluation

The resulting optical film samples and the polarizing plate samples were evaluated as follows. The results of evaluation are shown in Table 2 below.

### (a) Surface Profile

The surface profile of the optical film samples was measured in terms of surface roughness Ra, mean spacing between profile peaks Sm, average slope θa, and peak slope θp under the following conditions.

(a-1) Surface Roughness Ra

Centerline average surface roughness (Ra; unit: μm) was measured with Surfcorder SE-3F (from Kosaka Laboratory, Ltd.) in accordance with JIS B0601 (1982) under the conditions of assessment length: 2.5 mm; cut-off: 0.25 mm; scanning speed: 0.5 mm/s; stylus diameter: 2 μm; and load: 30 μN.

(a-2) Mean Spacing Between Profile Peaks Sm

Mean spacing between profile peaks at the mean line (a profile peak is the highest point of the profile between an upwards and downwards crossing of the mean line) was measured with Surfcoder SE-3F under the sane conditions as for the measurement of Ra.

(a-3) Average Slope (θa) and Peak Slope (θp)

θa and θp were calculated from the measured data obtained with SXM520-AS150 (from Macromap Corp.) as described supra.

### (b) Haze

The total haze (H) of the optical film was measured in accordance with JIS K7136.

The film was sandwiched between a pair of 1 mm thick microslide glass plates (S9111 from Matsunami Glass Ind., Ltd.) with a few drops of silicone oil spread between both sides of the film and the glass plates so as to achieve complete optical contact and thereby to eliminate a surface haze. In this state, the haze of the specimen was measured. Separately, the same glass plates were joined with silicon oil spread therebetween to make a control specimen. The difference of the measured haze values (of the film and the control) was taken as an internal haze (Hi) of the film.

The internal haze (Hi) as calculated was subtracted from the total haze (H) to give a surface haze (Hs) of the film.

### (c) Average Reflectance

The back side (triacetyl cellulose film side) of the optical film sample was roughened with sand paper, and black ink was applied to the roughened surface to eliminate reflection on the back side. The spectral reflectance on the surface side of the film sample was measured in a wavelength range of 380 to 780 nm with a spectrophotometer (from JASCO Corp.). An arithmetic average of the integrated reflectance over a wavelength range of 450 to 650 nm was taken as an average reflectance.

### (d) Depth of Blacks

LCDs having the polarizer plate sample with the low refractive index layer on the viewer's side were organoleptically evaluated for depth of blacks. A plurality of LCDs arranged sideways were relatively compared at a time. Blackness of the display in power-off mode and that in power-on mode (namely, blackness of a black image), both viewed from the front, were compared for every film and rated according to the following AA to C rating system based on the assumption that more intense blackness means more depth of images. The evaluation was made in a bright environment lighted with fluorescent lamps on the ceiling (illuminance on the display surface was 500 lux) at an angle of 5° and 45° from the vertical direction (=0° ) to the display surface. Reflection of the fluorescent lamps on the display was not seen from the position of a viewer at either angle.
AA: Deep shade of black at both angles (5° and 45°), giving a very sharp image.
A: Deep shade of black at both angles, giving a sharp image.
B: Grayish black at either or both angles, giving a less sharp image.
C: Grayish black at either or both angles, giving a dull image.

### (e) Antiglare Properties

The entire back side of the optical film sample was daubed with a black felt pen. A bare fluorescent lamp with no louver (8000 cd/m²) was reflected thereon at an angle of 5°, and the edge blurring degree of the reflected image as observed at an angle of −5° was rated according to the following AA to C rating system. Both sides of the fluorescent lamp were masked to make a line light source of 4 mm in width, and the reflected image was observed and rated in the same manner.
AA: The outline of both the bare fluorescent lamp and the line light source is slightly recognizable.
A: The outline of the bare fluorescent lamp is slightly recognizable. The outline of the line light source is relatively easily recognizable.
B: The outline of both the bare fluorescent lamp and the line light source is relatively easily recognizable.
C: The outline of both the bare fluorescent lamp and the line light source is clearly recognizable, or the reflected image is glaring.

### (f) Surface Texture

The entire back side of the optical film sample was daubed with a black felt pen and stuck to glass with a pressure-sensitive adhesive. The texture of the surface side of the optical film was evaluated with the naked eye and rated A to C.
A: Roughness of the surface texture is not unpleasant.
B: Roughness of the surface texture is unpleasant but non-problematic for practice use.
C: Roughness of the surface texture is unpleasant.

TABLE 2

| | | | | | Average | | | Depth | Antiglare | | | |
|---|---|---|---|---|---|---|---|---|---|---|---|---|
| Sample | Ra | Sm | Hs | Hi | Reflectance | | | of | Properties | | Surface | |
| No. | (μm) | (μm) | (%) | (%) | (%) | θa (°) | θp (°) | Blacks | 5° | 45° | Texture | Remark |
| 101 | 0.11 | 70 | 2.2 | 11 | 1.7 | 1.2 | 0.2 | AA | A | A | A | invention |
| 102 | 0.17 | 72 | 2.4 | 24 | 1.7 | 1.3 | 0.2 | AA | AA | A | A | invention |
| 103 | 0.22 | 85 | 3.0 | 22 | 1.7 | 1.5 | 0.2 | AA | AA | A | A | invention |
| 104 | 0.26 | 92 | 3.5 | 22 | 1.8 | 1.8 | 0.2 | AA | AA | A | A | invention |
| 105 | 0.16 | 63 | 2.3 | 18 | 1.7 | 2.0 | 0.2 | AA | A | A | A | invention |
| 106 | 0.20 | 88 | 2.7 | 16 | 1.7 | 1.1 | 0.2 | AA | AA | A | A | invention |
| 107 | 0.23 | 85 | 3.2 | 18 | 1.7 | 2.5 | 0.2 | A | AA | A | A | invention |
| 108 | 0.87 | 165 | 15.0 | 32 | 2.3 | 1.0 | 0.1 | AA | A | C | C | comparison |
| 109 | 0.04 | 43 | 0.4 | 18 | 1.6 | 3.5 | 0.7 | AA | C | C | A | comparison |
| 110 | 0.09 | 48 | 1.1 | 7 | 1.6 | 2.8 | 0.5 | B | C | B | A | comparison |
| 111 | 0.11 | 48 | 1.7 | 24 | 1.6 | 2.2 | 0.6 | C | C | C | A | comparison |
| 112 | 0.10 | 40 | 1.5 | 27 | 1.6 | 3.2 | 0.7 | C | C | C | A | comparison |
| 113 | 0.07 | 75 | 1.1 | 20 | 1.6 | 1.8 | 0.2 | AA | C | C | A | comparison |
| 114 | 0.45 | 60 | 5.5 | 18 | 2.0 | 3.2 | 0.7 | C | AA | A | B | comparison |
| 115 | 0.09 | 155 | 0.8 | 30 | 1.7 | 1.0 | 135.0 | AA | A | C | A | comparison |
| 116 | 0.19 | 111 | 2.7 | 18 | 1.7 | 1.2 | 0.2 | AA | AA | A | A | invention |
| 117 | 0.22 | 138 | 3.1 | 15 | 1.7 | 1.1 | 0.2 | AA | AA | A | A | invention |
| 118 | 0.1 | 65 | 3.5 | 13.0 | 1.7 | 1.4 | 0.2 | B | AA | AA | A | invention |
| 119 | 0.11 | 75 | 2.8 | 16.8 | 1.7 | 1.3 | 0.2 | AA | AA | A | A | invention |
| 120 | 0.12 | 80 | 2.0 | 21.4 | 1.7 | 1.3 | 0.2 | AA | AA | A | A | invention |
| 121 | 0.11 | 75 | 2.8 | 16.8 | 3.2 | 1.3 | 0.2 | A | AA | A | A | invention |

The results in Table 2 reveal the following. The optical films of the invention satisfy the desirable levels of optical performance as an antireflective antiglare film, such as average reflectance, depth of blacks, and antiglare properties. Excellent depth of blacks and antiglare performance can be obtained with a film thickness ranging from 8 to 15 μm by using light transmissive particles with their refractive indices and particle sizes falling within the specific ranges of the present invention. Comparative optical film sample 115, which satisfies the conditions of the invention except having an antiglare layer thickness of 22 μm, was uneasy to handle in the processing because of its large curling.

### Example 2

Antiglare films were made in the same manner as in Example 1, except that the low refractive index layer was not provided. Although the resulting antiglare film samples having the antiglare layer according to the invention had an integrated reflectance of 4.4 to 4.6% and provided reduced depth of blacks and increased reflection as compared with those of Example 1, they were still superior to comparative samples in depth of blacks and antiglare performance.

### Example 3

A polarizing plate was made by sandwiching a polarizer (an iodine-stained polyvinyl alcohol stretched film) between the triacetyl cellulose film side of each of the saponified optical films prepared in Examples 1 and 2 and an 80 μm thick triacetyl cellulose film (TAC-TD80U, from Fuji Film) having been immersed in a 1.5 mol/l aqueous sodium hydroxide solution kept at 55° C., followed by neutralization and washing with water to make a polarizing plate. The resulting polarizing plate was used in place of the polarizing plate on the viewer's side of a commercially available transmissive LCD (having a polarization separation film (D-BEF, from Sumitomo 3M Ltd.) between the backlight and the liquid crystal cell) of TN mode for a notebook PC, with its low refractive index layer side or the antiglare layer side facing out. As a result, the LCD exhibited very high display qualities, that is, excellent antiglare properties and depth of blacks, extremely reduced reflection of ambient light, and good contrast in bright lighting.

### Example 4

A polarizing plate was made in the same manner as in Example 1, except for replacing the protective film opposite to the optical film of the invention with an optical compensation film (Wide View Film Ace, from Fuji Film). The polarizing plate was disposed on the viewer's side of a transmissive TN liquid crystal cell with the optical film of the invention facing out. The same optical compensation film was used as a protective film on the liquid crystal cell side of the polarizing plate disposed on the backlight side of the liquid crystal cell. The thus assembled LCD exhibited high display qualities. That is, the LCD showed excellent antiglare properties and depth of blacks, extremely reduced reflection of ambient light, and good contrast in bright lighting. In addition, the LCD had extremely superior visibility in a very wide range of viewing angle in both the vertical and the horizontal directions.

### Example 5

A VA mode LCD (LC-26GD3, from Sharp Kabushiki Kaisya) having a polarizing plate containing a retardation layer on its viewer's side was used for evaluation. The polarizing plate except the retardation layer thereof was removed from the viewer's side of the LCD, and each of the polarizing plates prepared in Examples 1 and 2 was stuck instead with its transmission axis coincide with that of the original polarizing plate. The thus modified LCD exhibited very high display qualities. That is, the LCD was superior in antiglare performance and depth of blacks and showed extremely reduced reflection of ambient light, providing excellent contrast in bright lighting.

It was furthermore confirmed that the display having the polarizing plate prepared in Example 1 and the display having the polarizing plate prepared in Example 2 show a high antiglare effect and provide very good display performance with excellent contrast in oblique directions.

### Example 6

The polarizing plate was removed from an IPS mode LCD (Th-26LX300, from Matsushita Electric Industrial Co., Ltd.), and each of the polarizing plate prepared in Examples 1 and 2 was stuck instead with its transmission axis coinciding with that of the original polarizing plate. The thus modified LCDs exhibited very high display qualities. That is, the LCDs were superior in antiglare performance and depth of blacks and showed extremely reduced reflection of ambient light, providing excellent contrast in bright lighting.

### Example 7

Each of the optical film samples prepared in Examples 1 and 2 was stuck to the glass faceplate of an organic ELD via a pressure sensitive adhesive to provide a display device with high visibility owing to reduced reflection on the glass surface.

### Example 8

A polarizing plate having each of the optical film samples prepared in Examples 1 and 2 on one side of a polarizer was prepared. A quarter wave plate was stuck to the opposite side to the optical film of the invention. The polarizing plate was stuck to the glass faceplate of an organic ELD with the optical film of the invention facing out. The resulting ELD prevented reflection on the faceplate and reflection from the inside of the faceplate and therefore provided extremely high image visibility.

The foregoing examples prove that the optical film of the present invention exhibits favorable performance properties for use in image display devices for its superiority in antiglare performance and depth of blacks.

Although the invention has been described above in relation to preferred embodiments and modifications thereof, it will be understood by those skilled in the art that other variations and modifications can be effected in these preferred embodiments without departing from the scope and spirit of the invention.

What is claimed is:

1. An optical film comprising:
a transparent substrate; and
an antiglare layer comprising a light transmissive resin and a first light transmissive particle, and having a thickness of from 8 to 15 μm,
wherein the first light transmissive particle has a particle size of from 5.5 to 10 μm and a refractive index of from 1.55 to 1.58, and
a ratio of the particle size of the first light transmissive particle to the thickness of the antiglare layer is from 0.30 to 0.75.

2. The optical film of claim 1, wherein the antiglare layer further comprises a second light transmissive particle having a particle size being substantially same as the particle size of the first light transmissive particle.

3. The optical film of claim 2, wherein the second light transmissive particle has a refractive index of from 1.49 to 1.54.

4. The optical film of claim 1, further comprising a layer having a lower refractive index than the antiglare layer.

5. The optical film of claim 4, having an integrated reflectance of 3.5% or less.

6. The optical film of claim 1, having a surface profile with a centerline average roughness of from 0.05 to 0.25 μm and a mean spacing between profile peaks of from 60 to 150 μm.

7. The optical film of claim 1, having a surface profile having a slope distribution with an average slope of from 0.5° to 3.0° and a peak slope of 0.3° or less.

8. The optical film of claim 1, having a surface haze of from 0.2% to 10%.

9. The optical film of claim 1, having an internal haze of from 1% to 40%.

10. A polarizing plate comprising a polarizer and two protective films each protecting either side of the polarizer,
at least one of the protective films being the optical film of claim 1.

11. An image display device comprising the optical film of claim 1.

12. An image display device comprising the polarizing plate of claim 10.
